(19) United States
(12) Patent Application Publication
(10) Pub. No.: US 2008/0100510 A1
(43) Pub. Date: May 1, 2008

(54) Method and apparatus for microwave and millimeter-wave imaging

(76) Inventors: Andrew J. Bonthron, Los Angeles, CA (US); Gerald Juskovic, Newport Beach, CA (US)

Correspondence Address: IRELL & MANELLA LLP, 840 NEWPORT CENTER DRIVE, SUITE 400, NEWPORT BEACH, CA, 92660, US

(21) Appl. No.: 11/978,055

(22) Filed: Oct. 26, 2007

Related U.S. Application Data
(60) Provisional application No. 60/854,783, filed on Oct. 27, 2006.

(51) Int. Cl. H01Q 3/00

(52) U.S. Cl. 342/373

(57) ABSTRACT

An antennae system for a detector. The antennae system includes a two-dimensional electro-magnetic transmitter array that has an x number of transmitter elements, and a two-dimensional electro-magnetic receiver array that has a y number of receiver elements. The two-dimensional electro-magnetic transmitter and receiver arrays have a spatial relationship such that at least one subset of the two-dimensional electro-magnetic transmitter and receiver arrays forms a regular array of spatial displacements of z pairwise combinations of transmitter and receiver elements, where z is greater than the sum of x and y.

### CROSS-REFERENCE TO RELATED APPLICATIONS

This application claims priority to Application No. 60/854,783 filed on Oct. 27, 2006.

### BACKGROUND OF THE INVENTION

1. Technical Field of the Invention

The subject matter disclosed generally relates to the field of electronic systems and methods. More specifically, the subject matter disclosed relates to electronic arrangements that allow cost reduction and increased utility for microwave and millimeter-wave imaging applications.

2. Background of Related Art

Imaging sensors utilizing electromagnetic signals in the millimeter-wave frequency spectrum have demonstrated the ability to detect objects obscured from sight such as handguns concealed underneath clothing and metal objects inside of bags, due to the ability of signals in this frequency range to penetrate clothing and various other materials. For this discussion, the term “millimeter-wave” includes the microwave spectrum and refers to frequencies in the range of, but not limited to, 1 GHz-1 THz. Active versions of these sensors typically utilize a transmitted signal that reflects from objects, and is then received and processed to create an image of the differences of reflectivity of the objects. Passive versions of these sensors typically utilize a high sensitivity receiver to receive naturally emitted energy from objects to create an image of the thermal differences of the objects. Passive sensors can have an advantage of not requiring transmit circuitry, but typically have poorer image contrast in indoor applications, and also typically require a higher sensitivity receiver which can add cost.

The utility and performance of images created by millimeter-wave signals in detecting concealed weapons or identification of objects is typically related to image resolution. To increase the number of image pixels, reduce the size of image pixels, or provide higher image resolution, typically the size and cost of an imaging sensor is increased. This can be detrimental to application and deployment. In addition, image quality and weapon detection capabilities can be enhanced through the use of frequency modulation or multiple frequency operation of the sensor. This, however, typically adds cost and complexity to the sensor.

To facilitate mass deployment of millimeter-wave imaging sensors, reduction of the sensor cost, size, and weight, and improvement of the imaging performance are desirable. Some prior-art millimeter-wave imaging sensor methods for cost reduction utilize mechanical scanning of a fixed antenna or array of antennas to create a two-dimensional scanned image with a reduced number of millimeter-wave components. However, there exists a finite speed in which mechanical scanning can be performed, often on the order of one second or longer for practical systems. Such slow rates can cause image blurring or reduced performance in applications where the object being imaged is not still, or in handheld applications where the imaging sensor is not still during this scanning period. Electrically sequenced, or scanned, two-dimensional antenna arrays can provide a much faster scanning time, typically on the order of tens of milliseconds, but can suffer from high cost due to the millimeter-wave hardware for realization of the electrically sequenced or scanned two-dimensional antenna array.

It would be desirable to have an electrically sequenced or scanned two-dimensional active millimeter-wave imaging array with fast scan time and frequency modulation capability in a low-cost, mass-production-capable design. In addition, it would be desirable to have a low-cost mechanically-scanned array for applications where body or object motion blurring is not of concern. Also, it would be desirable to have a two-dimensional active millimeter-wave imaging array with complex signal sampling and frequency modulation capability compatible with digital beam-forming, super-resolution, two-dimensional and three-dimensional image processing techniques well known in the art, as well as weapon signature detection techniques such as, but not limited to, frequency response signatures. In addition, an implementation which has multiple polarization capability can have additional advantage. Furthermore, an implementation which has a small size, light weight, and portability can have further advantage.

### BRIEF SUMMARY OF THE INVENTION

An antennae system for a detector. The antennae system includes a two-dimensional electro-magnetic transmitter array that has an x number of transmitter elements, and a two-dimensional electro-magnetic receiver array that has a y number of receiver elements. The two-dimensional electro-magnetic transmitter and receiver arrays have a spatial relationship such that at least one subset of the two-dimensional electro-magnetic transmitter and receiver arrays forms a regular array of spatial displacements of z pairwise combinations of transmitter and receiver elements, where z is greater than the sum of x and y.

### BRIEF DESCRIPTION OF THE DRAWINGS

The accompanying drawings are for the purpose of illustrating and expounding the features involved in the present invention for a more complete understanding, and not meant to be considered as a limitation, wherein:

FIG. 1A is a block diagram illustrating features of one embodiment of an imaging sensor architecture according to aspects of the present invention.

FIG. 1B is a block diagram illustrating features of another embodiment of an imaging sensor architecture according to aspects of the present invention.

FIG. 1C is a block diagram illustrating features of an alternate embodiment of an imaging sensor architecture according to aspects of the present invention.

FIG. 1D is a block diagram illustrating features of an antenna arrangement according to aspects of the present invention.

FIG. 2A is a diagram illustrating received signal phase from an object across an antenna array aperture according to aspects of the present invention.

FIG. 2B is a diagram illustrating a transmit and receive antenna arrangement according to aspects of the present invention.

FIG. 2C is a diagram illustrating a one-dimensional virtual array arrangement according to aspects of the present invention.

FIG. 2D is a diagram illustrating a two-dimensional thinned-array transmit and receive antenna arrangement according to aspects of the present invention.

FIG. 2E is a diagram illustrating a two-dimensional virtual array arrangement according to aspects of the present invention.

FIG. 3A is a block diagram illustrating features of one embodiment of an antenna network according to aspects of the present invention.

FIG. 3B is a block diagram illustrating features of another embodiment of an antenna network according to aspects of the present invention.

FIG. 3C is a block diagram illustrating features of a further embodiment of an antenna network according to aspects of the present invention.

FIG. 4A is an electrical block diagram illustrating features of one embodiment of an imaging sensor architecture according to aspects of the present invention.

FIG. 4B is an electrical block diagram illustrating features of another embodiment of an imaging sensor architecture according to aspects of the present invention.

FIG. 5 is a diagram illustrating operational timing according to aspects of the present invention.

FIG. 6A is an electrical block diagram illustrating features of a further embodiment of an imaging sensor architecture according to aspects of the present invention.

FIG. 6B is an electrical block diagram illustrating features of a yet further embodiment of an imaging sensor architecture according to aspects of the present invention.

FIG. 6C is a diagram illustrating a two-dimensional thinned-array, dual-polarized transmit and receive antenna arrangement according to aspects of the present invention.

FIG. 7A is a block diagram illustrating features of one embodiment of the signal generator 405 according to aspects of the present invention.

FIG. 7B is a block diagram illustrating features of another embodiment of the signal generator 405 according to aspects of the present invention.

FIG. 7C is a block diagram illustrating features of a further embodiment of the signal generator 405 according to aspects of the present invention.

FIG. 7D is a block diagram illustrating features of a yet further embodiment of the signal generator 405 according to aspects of the present invention.

FIG. 7E is a block diagram illustrating features of another embodiment of the signal generator 405 according to aspects of the present invention.

FIG. 7F is a block diagram illustrating features of one embodiment of the TX & LO signal generator 407 according to aspects of the present invention.

FIG. 7G is a block diagram illustrating features of another embodiment of the TX & LO signal generator 407 according to aspects of the present invention.

FIG. 8A illustrates an output waveform from the signal generator 405 or TX & LO signal generator 407 in accordance with one embodiment of the present invention.

FIG. 8B illustrates an output waveform from the signal generator 405 or TX & LO signal generator 407 in accordance with another embodiment of the present invention.

FIG. 8C illustrates an output waveform from the signal generator 405 or TX & LO signal generator 407 in accordance with a further embodiment of the present invention.

FIG. 8D illustrates an output waveform from the signal generator 405 or TX & LO signal generator 407 in accordance with a yet further embodiment of the present invention.

FIG. 9A is a diagram illustrating antenna selection timing according to aspects of the present invention.

FIG. 9B is a diagram illustrating antenna selection timing according to aspects of the present invention.

FIG. 9C is a diagram illustrating antenna selection timing according to aspects of the present invention.

FIG. 9D is a diagram illustrating antenna selection timing according to aspects of the present invention.

FIG. 9E is a diagram illustrating antenna selection timing according to aspects of the present invention.

FIG. 9F is a diagram illustrating A/D converter sample timing according to aspects of the present invention.

### DETAILED DESCRIPTION

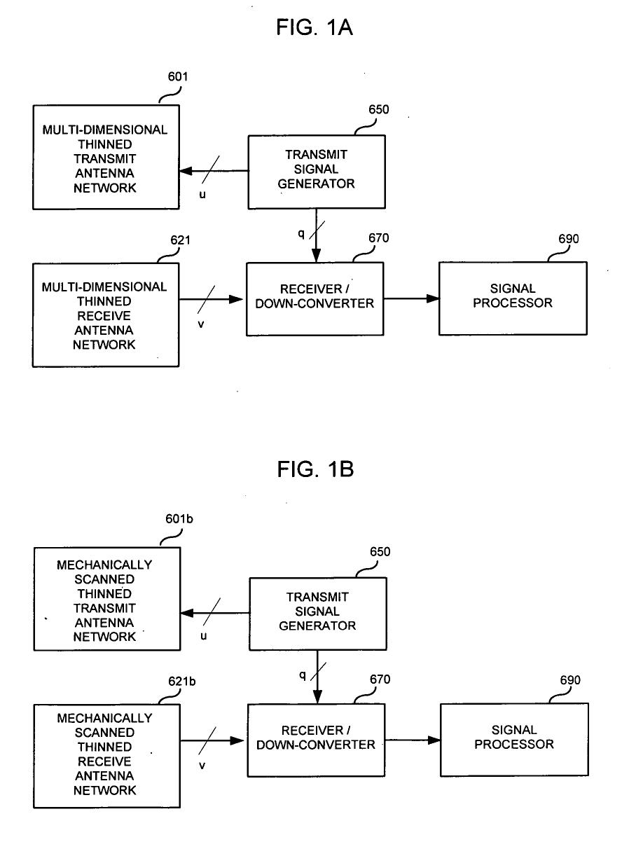

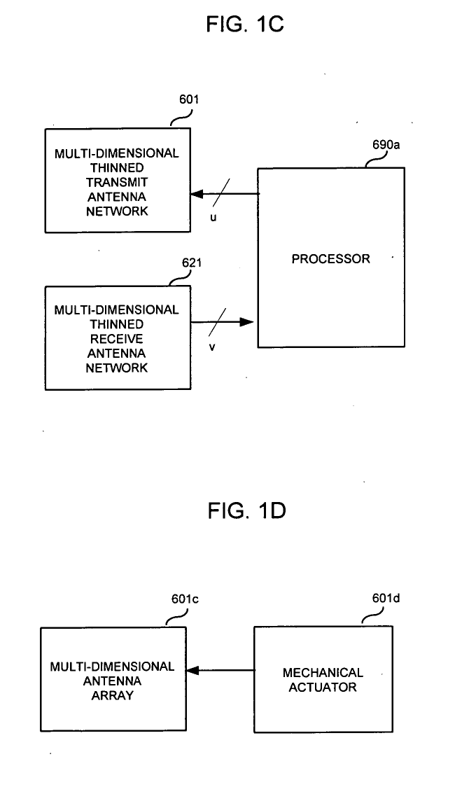

An imaging sensor arrangement is presented in FIG. 1A as one embodiment of aspects of the present invention. In this arrangement, the transmit signal generator 650 outputs u signals to a multi-dimensional thinned transmit antenna network 601 for electromagnetic transmission, where u is an integer greater than or equal to 1. A typical frequency of the transmitted signal from the multi-dimensional thinned transmit antenna network 601 can be within, but is not limited to, the frequency range of 1 GHz-1 THz, and can be a fixed frequency or be frequency modulated. The imaging sensor's total occupied transmit spectral bandwidth is dependent on the frequency modulation bandwidth, and can be wideband (WB) or ultra-wideband (UWB) in order to achieve adequate range resolution for some applications. A typical WB bandwidth value can be, but is not limited to, a value greater than 100 MHz. A typical UWB bandwidth value can be, but is not limited to, a value greater than 1 GHz. The reflected signal from an object is received by the multi-dimensional thinned receive antenna network 621, which outputs v signals to a receiver/down-converter 670, where v is an integer greater than or equal to 1. The receiver/down-converter 670 also accepts q signals from the transmit signal generator 650, where q is an integer greater than or equal to 1, and outputs one or a plurality of signals each comprising at least one of the frequency or phase difference between components of the transmitted signal and corresponding received reflected signal from an object as an input to a signal processor 690. The receiver/down-converter 670 can utilize one or a plurality of down-conversion operations in generating the output difference signals. The transmit signal generator 650 can include, but is not limited to, generation of one or a plurality of fixed frequency or frequency modulated signals, intermediate frequency signal generation, local oscillator signal generation, transmit and/or receive gating signal generation, or transmit pulsing signal generation. The multi-dimensional thinned transmit antenna network 601 can include, but is not limited to, a two-dimensional array of spatially separated antennas, multiple one-dimensional arrays arranged in multiple axes, a conformal array of spatially separated antennas, a three-dimensional array of spatially separated antennas, or one or a plurality of groups of spatially separated antennas with one or a plurality of antennas simultaneously selected for transmission of one or a plurality of signals, wherein at least two adjacent antennas have a distance between them that is different than at least two adjacent antennas in the multi-dimensional thinned receive antenna network 621. The multi-dimensional thinned receive antenna network 621 can include, but is not limited to, a two-dimensional array of spatially separated antennas, multiple one-dimensional arrays arranged in multiple axes, a conformal array of spatially separated antennas, a three-dimensional array of spatially separated antennas or one or a plurality of groups of spatially separated antennas with one or a plurality of antennas simultaneously selected for reception of one or a plurality of signals, wherein at least two adjacent antennas have a distance between them that is different than at least two adjacent antennas in the multi-dimensional thinned transmit antenna network 601. According to aspects of the present invention, the multi-dimensional thinned transmit antenna network 601 and the multi-dimensional thinned receive antenna network 621 are utilized to synthesize an array having more elements than the sum of the elements contained in multi-dimensional thinned transmit antenna network 601 and the multi-dimensional thinned receive antenna network 621, for the purpose of reducing the sensor hardware necessary for imaging applications. The term “thinned” in this application refers to the utilization of a lower number of physical transmit and receive antenna elements to synthesize an array with a larger number of synthesized or virtual elements than the sum of the physical transmit and receive elements. The term “imaging” in this application includes, but is not limited to, multi-dimensional object image construction, detection or identification of objects using, but not limited to, image processing or image recognition techniques, and/or object signatures such as, but not limited to, radar cross-section signatures, angular cross-section signatures, range cross-section signatures, wideband or ultra-wideband frequency response signatures, wideband or ultra-wideband frequency resonance signatures, or polarization signatures. Examples of objects that may be detected using imaging techniques can include, but are not limited to, concealed weapons, guns, knives, explosives, contraband, or improvised explosive devices (IED's).

Signal processor 690 may comprise a single or plurality of individual processors. Signal processor 690 may perform, but is not limited to, any single or combination of the functions of signal or image processing, real or complex DFT or FFT signal processing, CFAR threshold detection, spectral peak detection, target peak association, frequency measurement, magnitude measurement, phase measurement, magnitude scaling, phase shifting, spatial FFT processing, digital beam-forming (DBF) processing, super-resolution processing such as, but not limited to, the use of the multiple signal classification algorithm (MUSIC) or the estimation of signal parameters via rotational invariance techniques (ESPRIT) algorithm, neural network processing, two-dimensional image processing, three-dimensional image processing, two or three-dimensional image reconstruction processing, microwave or millimeter-wave holography processing, backward-wave reconstruction processing, wavefront reconstruction processing, synthetic aperture radar (SAR) processing, or Kirchoff diffraction integral processing. Additional processing techniques used in the above-mentioned functions may include, but are not limited to, windowing, digital filtering, Hilbert transform, least squares algorithms, or non-linear least squares algorithms. Furthermore, one or a combination of object signature methods can be used to determine the presence or identification of potential threats, weapons or contraband such as, but not limited to, radial cross-section characteristics, angular cross-section characteristics, strength of returns, wideband or ultra-wideband frequency response characteristics, wideband or ultra-wideband frequency resonance characteristics, polarization response characteristics, spectral absorption characteristics, or image shape characteristics, and such signatures may be determined for the entire object or for one or more regions of an object or detection zones. The signal processor may include, but is not limited to, one or more digital signal processors (DSPs), microprocessors, micro-controllers, electrical control units, or other suitable processor blocks.

An imaging sensor arrangement is presented in FIG. 1B as another embodiment of aspects of the present invention. The arrangement in FIG. 1B is similar to the arrangement in FIG. 1A, except that instead of the multi-dimensional thinned transmit antenna network 601 and multi-dimensional thinned receive antenna network 621, a mechanically scanned thinned transmit antenna network 601b and mechanically scanned thinned receive antenna network 621b are utilized. The same components are denoted by the same reference numerals, and will not be explained again. In this arrangement, the transmit signal generator 650 outputs u signals to a mechanically scanned thinned transmit antenna network 601b for electromagnetic transmission, where u is an integer greater than or equal to 1. A typical frequency of the transmitted signal from the mechanically scanned thinned transmit antenna network 601b can be within, but is not limited to, the frequency range of 1 GHz-1 THz, and can be a fixed frequency or be frequency modulated. The imaging sensor's total occupied transmit spectral bandwidth is dependent on the frequency modulation bandwidth, and can be wideband (WB) or ultra-wideband (UWB) in order to achieve adequate range resolution for some applications. The reflected signal from an object is received by the mechanically scanned thinned receive antenna network 621b, which outputs v signals to a receiver/down-converter 670, where v is an integer greater than or equal to 1. The receiver/down-converter 670 also accepts q signals from the transmit signal generator 650, where q is an integer greater than or equal to 1, and outputs one or a plurality of signals each comprising at least one of the frequency or phase difference between components of the transmitted signal and corresponding received reflected signal from an object as an input to a signal processor 690. This arrangement utilizes a one-dimensional or multi-dimensional thinned transmit array and a one-dimensional or multi-dimensional thinned receive array, mechanically scanned or dithered in one or more directions for the purpose of sampling different spatial positions for the elements along the mechanically scanned or dithered direction. For example, not meant as a limitation, a one-dimensional azimuth line-array consisting of a transmit array with spacing D and a receive array with spacing different than D and a position where there is no overlap in the azimuth dimension between transmit and receive arrays, is mechanically scanned in the elevation dimension. Through spatial sampling at various positions in elevation during the mechanical scanning in that dimension, a two dimensional set of array measurements is achieved and can be utilized for image processing. In another example, not meant as a limitation, a two-dimensional thinned transmit array and a two-dimensional thinned receive array are utilized, where one or both of the arrays utilize positional dithering in one or more directions in order to provide additional spatial sampling positions in the synthesis of a virtual array. The thinned transmit and receive arrays are utilized to reduce the hardware necessary for the imaging sensor, as is the mechanical scanning and spatial sampling along the mechanical scanning path. When the thinned array and mechanical scanning methods are utilized in combination, the sensor hardware required and/or sensor cost can be reduced for applications where the mechanical scan time is acceptable.

An imaging sensor arrangement is presented in FIG. 1C as an alternate embodiment of aspects of the present invention. The arrangement in FIG. 1C is similar to the arrangement in FIG. 1A, except that a processor 690a provides u output signals to a multi-dimensional thinned transmit antenna network 601 for electromagnetic transmission, and accepts v input signals from a multi-dimensional thinned receive antenna network 621, where u and v are each integers greater than or equal to 1. The same components are denoted by the same reference numerals, and will not be explained again. A typical frequency of the transmitted signal from the multi-dimensional thinned transmit antenna network 601 can be within, but is not limited to, the frequency range of 1 GHz-1 THz, and can be a fixed frequency or be frequency modulated. The imaging sensor's total occupied transmit spectral bandwidth is dependent on the frequency modulation bandwidth, and can be wideband (WB) or ultra-wideband (UWB) in order to achieve adequate range resolution for some applications. In addition, this arrangement can be mechanically scanned or dithered in one or more directions for the purpose of sampling different spatial positions for the elements along the mechanically scanned or dithered direction.

An antenna arrangement with mechanical movement capability is presented in FIG. 1D as an embodiment of aspects of the present invention. The example of an antenna arrangement with mechanical movement capability shown in FIG. 1D is for illustration purposes and is not considered a limitation. In this arrangement, a mechanical actuator 601d provides mechanical movement of a multi-dimensional antenna array 601c in one or more directions. The arrangement shown in FIG. 1D can be utilized to provide mechanical movement for a transmit array, a receive array, or both transmit and receive arrays in one or more directions. In addition, the arrangement shown in FIG. 1D can be utilized to provide mechanical dithering for a transmit array, a receive array, or both transmit and receive arrays in one or more directions. Furthermore, the arrangement shown in FIG. 1D can be utilized to provide mechanical scanning for a transmit array, a receive array, or both transmit and receive arrays in one or more directions.

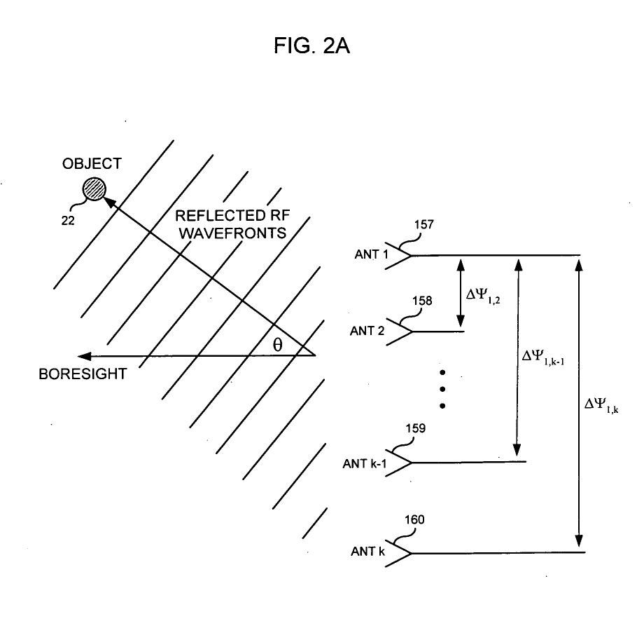

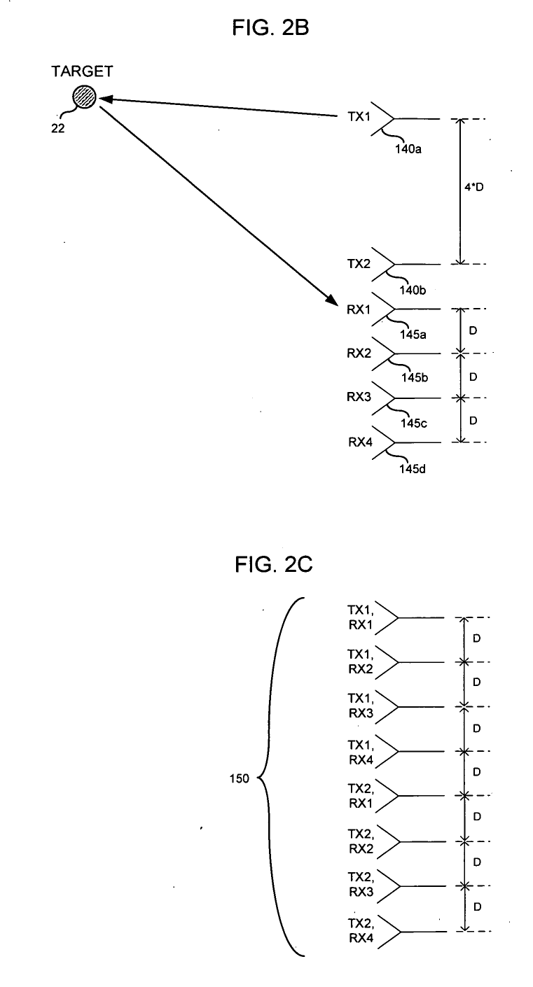

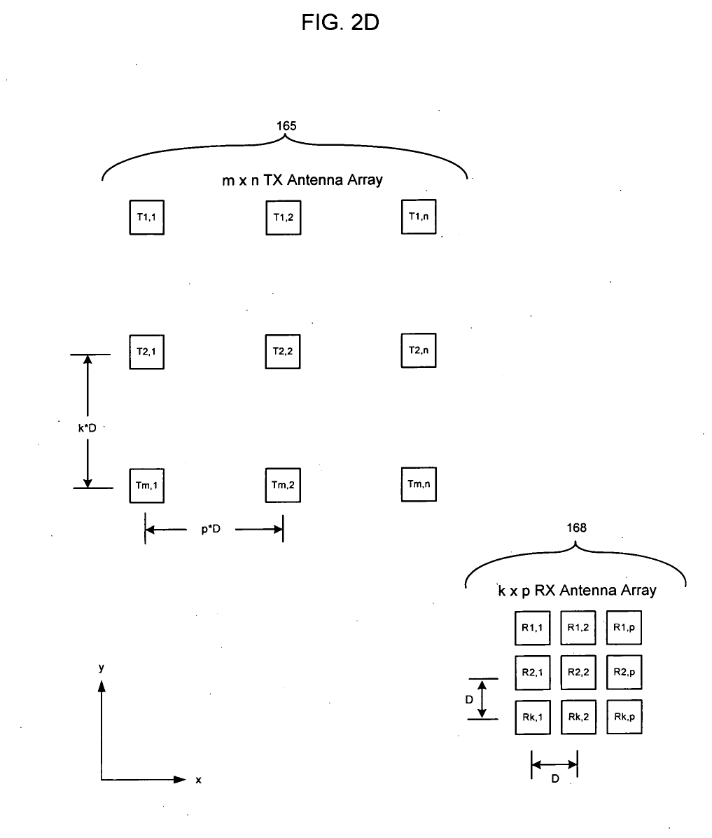

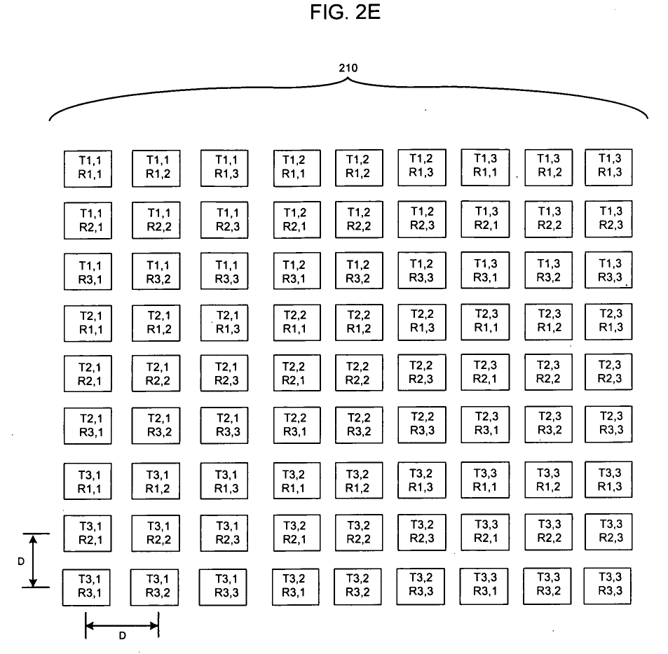

FIG. 2A illustrates the phase shift in received signals from an object 22 for spatially separated antennas 157, 158, 159, 160 across an array, according to aspects of the present invention. The example of antenna spatial separation shown in FIG. 2A is for illustration purposes and is not considered a limitation. In this arrangement, k antennas 157, 158, 159, 160 are separated from one another in the axis of object direction (θ determination as illustrated in FIG. 2A. The axis of object direction determination can be, but is not limited to, the azimuth or the elevation axis. As can be seen, the received reflected signals from object 22 at angle θ from boresight will generate phase shifts ΔΨ_{1,2}, ΔΨ_{1,k-1}, ΔΨ_{1,k} between ANT 1 and the other antenna elements due to the angle of the reflected RF wavefronts as illustrated. For an antenna array, these received phase shifts can be utilized to determine the direction of an object, and it is the unique spatial position of the elements in the array that allows unique phase sampling of the received signals across the array. The concept of building an array from a set of unique phase length combinations between transmit and receive elements makes it possible for a thinned transmit and thinned receive array to synthesize an array having a larger number of elements than the sum of the transmit and receive array elements, which is termed a “virtual array” in the present invention.

Through selection of various combinations of transmit and receive antenna pairs, a receive antenna array, or virtual array, is synthesized with the number of elements and spacing of elements based upon the number of unique transmit and receive pairs selected and the physical spacing between the elements of these pairs. Let the physical transmit antenna elements 140a, 140b and receive antenna elements 145a, 145b, 145c, 145d be spaced in the axis of target direction determination as illustrated in FIG. 2B. Let transmit antenna TX1 be selected and receive antenna RX1 be selected simultaneously. During the radar dwell time let the down-converted signals be digitized and stored. Then let the receive element RX2 be selected for the next radar dwell time during which the down-converted signals be digitized and stored. Perform the same operations for the elements RX3 and RX4. Repeat the above receive antenna selection settings for the next four radar dwell times but with the transmit antenna TX2 selected instead of the transmit antenna TX1. When completed, digitized down-converted signals corresponding to 8 combinations of transmit and receive antenna selections will be stored and can be used for image processing. The 8 combinations of transmit and receive antenna selections can be used to synthesize a receive virtual array 150 of 8 elements with each element having a center-to-center spacing of D as illustrated in FIG. 2C. As an example, not meant as a limitation, let the antenna combination of TX1 RX1 be utilized for the received signal reference. Then the next antenna combination in the virtual array, which is TX1 RX2 in FIG. 2C, will have a relative amplitude and phase of the received signal with respect to the received signal reference that is equivalent to that of an antenna element being offset by distance D from the reference element as shown. Continuing the example, the third element in the virtual array, which is TX1 RX3 in FIG. 2C, will have a relative amplitude and phase of the received signal with respect to the received signal reference that is equivalent to that of an antenna element being offset by distance 2*D from the reference element as shown. This can be repeated for all the elements in the virtual array. One advantage of using the thinned transmit and thinned receive arrays illustrated in FIG. 2B is that only 6 antenna elements were needed to synthesize an 8-element virtual array as shown in FIG. 2C resulting in a reduction in hardware. For larger one-dimensional or two-dimensional thinned arrays, the hardware savings can be much greater. The example illustrated in FIG. 2B is for a one-dimensional array where the spacing distance between the transmit and receive elements is utilized in synthesizing a one-dimensional virtual array. For multi-dimensional arrays, the spatial displacement between selected transit and receive element pairs must be used in synthesizing the virtual array element spatial positions rather than the spacing between them as for the one-dimensional array. The spatial displacement is a vector quantity which is composed of the scalar displacement values in each of the dimensions of the multi-dimensional arrays. For example, for two-dimensional transmit and receive arrays, the spatial displacement between a selected pair of transmit and receive elements would include a scalar value for the difference in x coordinates between the elements, and a scalar value for the difference in y coordinates between the elements. It is the set of unique spatial displacements between transmit and receive element pairs that is utilized to synthesize a multi-dimensional virtual array.

The thinned array arrangement shown in FIG. 2B can be modified according to aspects of the present invention. One example of such a modification, not meant as a limitation, can be to utilize a spacing between receive antenna elements that is greater than a spacing between transmit antenna elements. As an example, not meant as a limitation, the antenna elements 140a, 140b in FIG. 2B can be utilized for a receive function, and the antenna elements 145a, 145b, 145c, 145d can be utilized for a transmit function as part of a thinned array configuration. Another example of such a modification, not meant as a limitation, can be to utilize a non-uniform spacing between elements.

A two-dimensional, bi-static thinned-array arrangement is presented in FIG. 2D as one embodiment of aspects of the present invention. In this arrangement, a k by p RX antenna array 168 is illustrated with an element-to-element spacing of D in each axis, and an m by n TX antenna array 165 is illustrated with an element-to-element spacing of k*D in the y-axis and p*D in the x-axis, where m and n are non-zero integers whose sum is greater than or equal to 3, and k and p are non-zero integers whose sum is greater than or equal to 3. In this arrangement, the TX antenna array 165 and RX antenna array 168 are illustrated to be oriented diagonally with respect to each another, where the rows of the TX antenna array 165 span a range in the x-axis that is non-overlapping with the span of the rows of the RX antenna array 168 in the x-axis, and the columns of the TX antenna array 165 span a range in the y-axis that is non-overlapping with the span of the columns of the RX antenna array 168 in the y-axis. Whether the arrays are one-dimensional or multi-dimensional, utilizing non-overlapping arrays allows synthesis of a virtual array having an order equal to the multiplication of the orders of the smaller arrays. As an example, using this arrangement, an (m*k) by (n*p) array having m*n*k*p elements can be synthesized from the unique combinations of transmit and receive elements, resulting in a reduction in sensor hardware. As an example, not meant as a limitation, let m=n=k=p=3. For this exemplary arrangement, the synthesized 9-by-9 virtual array 210 is illustrated in FIG. 2E according to aspects of the present invention. In the virtual array 210, let the antenna combination T1,1 R1,1 be defined as the reference element in the virtual array 210, and let the received signal for that reference element be defined as the reference signal for the virtual array 210. The remaining elements of the virtual array 210 have relative spatial displacements from the reference element that correspond to the sum of the relative spatial displacements of the physical transmit and receive element pair with respect to the physical T1,1 R1,1 element pair that represents the reference element in the virtual array 210. Since all the sums of the relative spatial displacements of the physical transmit and receive element pairs with respect to the physical T1,1 R1,1 element pair are unique, the corresponding relative spatial positions in the virtual array 210 with respect to the reference element are unique, resulting in a fully populated virtual array having a number of virtual elements that is far greater than the sum of the physical transmit and receive elements that was used to synthesize it. Using that definition of reference element in the virtual array 210, the antenna combinations indicated in the virtual array 210 will have a relative amplitude and phase of the corresponding received signal with respect to the defined reference signal that is equivalent to that of an antenna element having a physical position relative to the reference element as shown in FIG. 2E. Since many image processing techniques, such as, but not limited to, digital beam-forming processing, utilize the relative phase of measurements made between elements in a two-dimensional array, the absolute phase resulting from the positional offset of the RX antenna array 168 relative to the TX antenna array 165 can be non-critical, since it is the relative distances between elements within each array that affects the synthesized virtual array configuration. However, it may be advantageous to have the TX and RX arrays close to one another to avoid other issues that may cause performance degradation, such as, but not limited to, the difference in transmit illumination angles versus reception angles, or performance of the virtual array for imaging objects that are closer than the far-field. The digitized, down-converted signals corresponding to the transmit and receive antenna combinations illustrated in the virtual array in FIG. 2E can be utilized for object imaging, through the use of image processing techniques well known in the art, such as, but not limited to, digital beam-forming (DBF) processing, super-resolution processing, such as, but not limited to, the use of the multiple signal classification algorithm (MUSIC), or the estimation of signal parameters via rotational invariance techniques (ESPRIT) algorithm, spatial Fourier transform processing, two-dimensional image processing, three-dimensional image processing, two or three-dimensional image reconstruction processing, microwave or millimeter-wave holography processing, backward-wave reconstruction processing, wavefront reconstruction processing, synthetic aperture radar (SAR) processing, or Kirchoff diffraction integral processing. The examples shown are meant as an illustration of virtual array synthesis techniques, not as a limitation. For example, not meant as a limitation, the distance between elements in each array need not be constant, but can be varied or be given multiple different values by one skilled in the art for advantage. In addition, not meant as a limitation, the spacing between receive array elements can be greater than the spacing between transmit array elements. As an example, not meant as a limitation, the antenna array 168 can be utilized for a transmit function and the antenna array 165 can be utilized for a receive function as part of a thinned array configuration. Another example, not meant as a limitation, can be for a transmit array to be a one-dimensional array positioned at an angle or orthogonal to a one-dimensional receive array for the purpose of synthesizing a virtual array without departing from the spirit of the present invention. Furthermore, overlapping or intertwined transmit and receive arrays may be utilized to synthesize a virtual array without departing from the spirit of the present invention. Other array sizes and configurations can be implemented by one of ordinary skill in the art without departing from the spirit of the present invention.

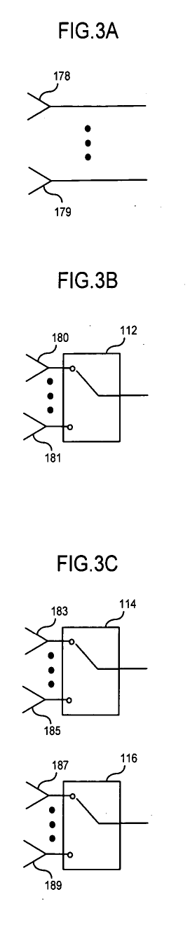

An antenna arrangement is illustrated in FIG. 3A as one embodiment of the multi-dimensional thinned transmit antenna network 601, as one embodiment of the multi-dimensional thinned receive antenna network 621, as one embodiment of the mechanically scanned thinned transmit antenna network 601b, and as one embodiment of the mechanically scanned thinned receive antenna network 621b according to aspects of the present invention. In this arrangement, a plurality of antennas 178, 179 are connected to the u transmit signals and/or v receive signals as defined in FIGS. 1A-B. The antennas can be arranged in a one-dimensional array, two-dimensional array, a conformal array, or a multi-dimensional array according to aspects of the present invention. The antennas can each have similar characteristics to one another, or can have different characteristics from one another depending on the requirements of the application. In addition, the antennas can have a polarization such as, but not limited to, linear polarization, circular polarization, or dual polarization according to aspects of the present invention.

An antenna arrangement is illustrated in FIG. 3B as another embodiment of the multi-dimensional thinned transmit antenna network 601, as another embodiment of the multi-dimensional thinned receive antenna network 621, as another embodiment of the mechanically scanned thinned transmit antenna network 601b, and as another embodiment of the mechanically scanned thinned receive antenna network 621b according to aspects of the present invention. In this arrangement, a selector 112 selectively establishes a connection between each of a plurality of antennas 180, 181 and a common input or output connection depending on whether the selector is used for a transmit or receive application respectively. In this way, this arrangement can be used to sequentially select between a number of antenna elements, and can be utilized to enable electrical sequencing or scanning of antenna arrays. A selector 112 can be used with each or any of the u transmit signals and/or v receive signals as defined in FIGS. 1A-B. Selector 112 can be implemented by, but is not limited to, a switch or a combination of switches, variable attenuators, or a combination of switched amplifiers and signal combiners/splitters wherein switching the gain/loss of said amplifiers is used for the selection function and said signal combiners/splitters can be implemented by, but are not limited to, Wilkinson combiners/splitters. One advantage of using switched amplifiers and signal combiners/splitters as a selection means is the elimination of the signal loss associated with series selection switches. The antennas can each have similar characteristics to one another, or can have different characteristics from one another depending on the requirements of the application. The antennas can be arranged in a one-dimensional array, two-dimensional array, a conformal array, or a multi-dimensional array according to aspects of the present invention. In addition, the antennas can have a polarization such as, but not limited to, linear polarization, circular polarization, or dual polarization according to aspects of the present invention.

An antenna arrangement is illustrated in FIG. 3C as a further embodiment of the multi-dimensional thinned transmit antenna network 601, as a further embodiment of the multi-dimensional thinned receive antenna network 621, as a further embodiment of the mechanically scanned thinned transmit antenna network 601b, and as a further embodiment of the mechanically scanned thinned receive antenna network 621b according to aspects of the present invention. In this arrangement, a plurality of selectors 114, 116 are used to select between antennas in a plurality of antenna groups. Selector 114 selectively establishes a connection between each of the plurality of antennas 183, 185 in one antenna group and a common input or output connection depending on whether the selector is used for a transmit or receive application respectively. Similarly, selector 116 selectively establishes a connection between each of the plurality of antennas 187, 189 in another antenna group and a common input or output connection depending on whether the selector is used for a transmit or receive application respectively. In this way, this arrangement can be used to sequentially select between a number of antenna elements, and can be utilized to enable electrical sequencing or scanning of antenna arrays. Selectors 114, 116 can be used with each or any of the u transmit signals and/or v receive signals as defined in FIGS. 1A-B. Selectors 114, 116 can be implemented by, but are not limited to, switches or a combination of switches, variable attenuators, or combinations of switched amplifiers and signal combiners/splitters. The antennas can each have similar characteristics to one another, or can have different characteristics from one another depending on the requirements of the application. The antennas can be arranged in a one-dimensional array, two-dimensional array, a conformal array, or a multi-dimensional array according to aspects of the present invention. In addition, the antennas can have a polarization such as, but not limited to, linear polarization, circular polarization, or dual polarization according to aspects of the present invention.

In addition, the multi-dimensional thinned transmit antenna network 601 and the multi-dimensional thinned receive antenna network 621 can share one or a plurality of antennas according to aspects of the present invention. Furthermore, the mechanically scanned thinned transmit antenna network 601b and the mechanically scanned thinned receive antenna network 621b can share one or a plurality of antennas according to aspects of the present invention.

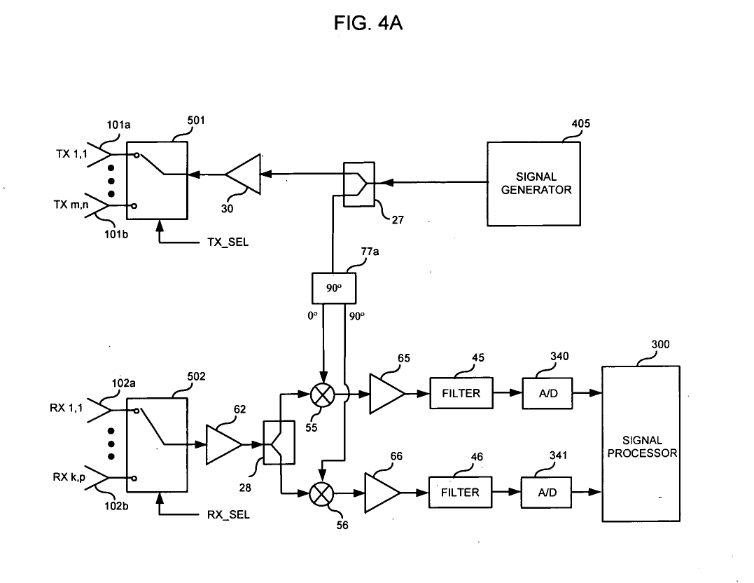

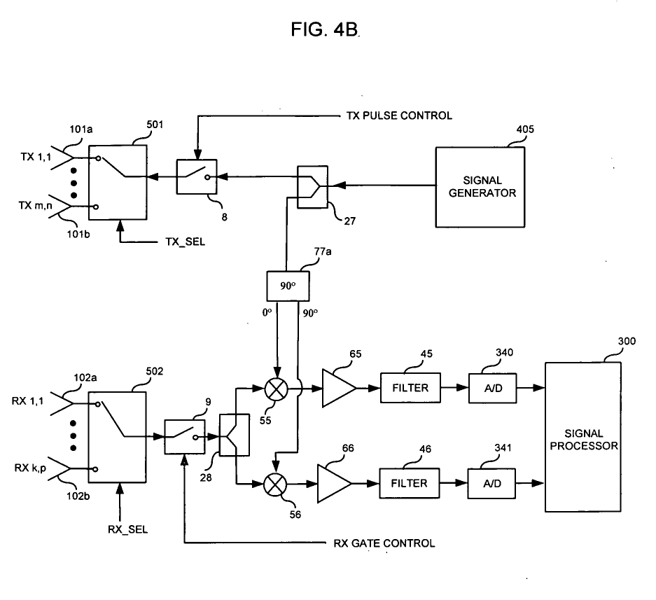

An imaging sensor arrangement is presented in FIG. 4A as one embodiment of aspects of the present invention. In this arrangement, a signal generated by the signal generator 405 is split by a signal splitter 27, where one portion of the signal proceeds to an amplifier 30 where it is amplified prior to proceeding to a selector 501. The selector 501 is used to selectively connect the signal to one of a plurality of an antennas 101a, 101b, designated by TX 1,1, TX m,n, where m and n are non-zero integers whose sum is greater than or equal to 3, for transmission in a sequential manner. A signal designated as TX_SEL controls which antenna 101a, 101b is selected by selector 501. A typical frequency of the transmission signal can be within, but is not limited to, the frequency range of 1 GHz-1 THz, and can be a fixed frequency or be frequency modulated. The imaging sensor's total occupied transmit spectral bandwidth is dependent on the frequency modulation bandwidth, and can be wideband (WB) or ultra-wideband (UWB) in order to achieve adequate range resolution for some applications. A typical WB bandwidth value can be, but is not limited to, a value greater than 100 MHz. A typical UWB bandwidth value can be, but is not limited to, a value greater than 1 GHz. The arrangement of the antennas 101a, 101b can be, but is not limited to, a one-dimensional array, a two-dimensional array, a three-dimensional array, multiple one-dimensional arrays arranged in multiple axes, or a conformal array. The reflected signal from an object is received by a plurality of receive antennas 102a, 102b, designated by RX 1,1, RX k,p, where k and p are non-zero integers whose sum is greater than or equal to 3. The arrangement of the receive antennas 102a, 102b can be, but is not limited to, a one-dimensional array, a two-dimensional array, a three-dimensional array, multiple one-dimensional arrays arranged in multiple axes, or a conformal array. A selector 502 is used to selectively connect one receive antenna at a time with the low noise amplifier 62 where the received signal is amplified prior to being split by splitter 28. A signal designated as RX_SEL controls which antenna 102a, 102b is selected by selector, 502. One of the outputs from splitter 28 is input to mixer 55, which mixes the signal with the 0-degree phase output signal from the 90-degree splitter 77a, and the other output from splitter 28 is input to mixer 56, which mixes the signal with the 90-degree phase output signal from the 90-degree splitter 77a, creating in-phase (I) and quadrature (Q) down-converted signals. The I and Q down-converted signals are then amplified by amplifiers 65, 66 and filtered by filters 45, 46 prior to sampling by A/D converters 340, 341. The resulting sampled I and Q signals are then input to signal processor 300 for signal processing.

The block diagram shown in FIG. 4A can be modified according to aspects of the present invention. One example of such a modification, not meant as a limitation, can be to not perform complex (I and Q) signal down-conversion or to perform it digitally in the signal processor, only having one down-converting mixer path to a single A/D converter, and to modify the block diagram accordingly. Another example of such a modification, not meant as a limitation, can be for the sensor architecture to use remote signal processing, remote analog-to-digital (A/D) conversion, or shared processing and/or A/D conversion with another sensor or system. A further example of such a modification, not meant as a limitation, can be for the sensor architecture to replace one or both of the selectors 501, 502 with a plurality of switched amplifiers and signal combiners, utilizing the gain/loss of the switched amplifiers to realize an antenna selection and routing function. A yet further example of such a modification, not meant as a limitation, can be for the sensor architecture to utilize any of the antenna networks illustrated in FIGS. 3A-C for any or both of the transmit or receive selectors and antenna functions. Another example of such a modification, not meant as a limitation, can be for the sensor architecture to use a plurality of simultaneously selected transmit signals and/or a plurality of simultaneously selected receive signals connected to a plurality of receiver/down-converter circuits. Mixers 55, 56 can be implemented by, but are not limited to, mixers, multipliers, or switches without changing the basic functionality of the arrangement. Filters 45, 46 can be implemented by, but are not limited to, low-pass filters or band-pass filters. Signal splitters 27, 28 can be implemented by, but are not limited to, Wilkinson power dividers, passive splitters, active splitters, or microwave couplers. A variety of amplifiers, filters, or other system elements known to those skilled in the art, such as low-noise amplifiers, power amplifiers, drivers, buffers, gain blocks, gain equalizers, logarithmic amplifiers, equalizing amplifiers, switches, and the like, can be added to or deleted from the described arrangement, or the position of existing elements may be modified, without changing the basic form or spirit of the invention.

Signal processor 300 shown in FIG. 4A may comprise a single or plurality of individual processors. Signal processor 300 may perform, but is not limited to, any single or combination of the functions of signal or image processing, real or complex DFT or FFT signal processing, CFAR threshold detection, spectral peak detection, target peak association, frequency measurement, magnitude measurement, phase measurement, magnitude scaling, phase shifting, spatial FFT processing, digital beam-forming (DBF) processing, super-resolution processing such as, but not limited to, the use of the MUSIC or ESPRIT algorithms, neural network processing, two-dimensional image processing, three-dimensional image processing, two or three-dimensional image reconstruction processing, microwave or millimeter-wave holography processing, backward-wave reconstruction processing, wavefront reconstruction processing, synthetic aperture radar (SAR) processing, or Kirchoff diffraction integral processing. Additional processing techniques that can be used with the abovementioned methods may include, but are not limited to, windowing, digital filtering, Hilbert transform, least squares algorithms, or non-linear least squares algorithms. Furthermore, one or a combination of object signature methods can be used to determine the presence or identification of potential threats, weapons or contraband such as, but not limited to, radial cross-section characteristics, angular cross-section characteristics, strength of returns, wideband or ultra-wideband frequency response characteristics, wideband or ultra-wideband frequency resonance characteristics, polarization response characteristics, or image shape characteristics, and such signatures may be determined for the entire object or for one or more regions of an object. In addition, the object signature methods can utilize complex signal attributes such as amplitude and/or phase. The signal processor may include, but is not limited to, one or more digital signal processors (DSPs), microprocessors, micro-controllers, electrical control units, or other suitable processor blocks.

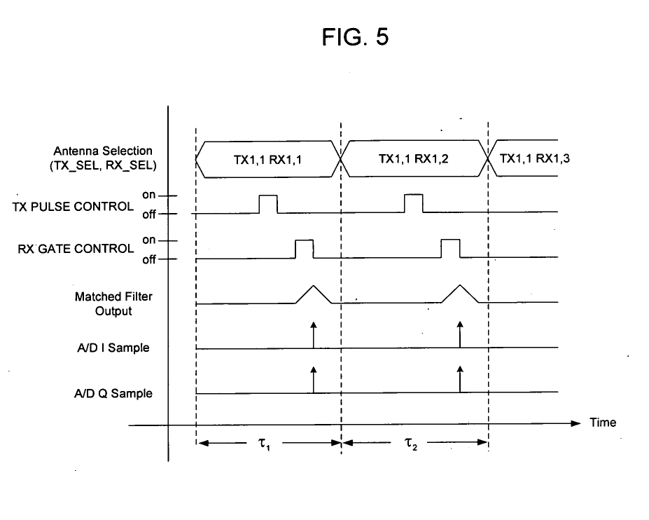

An imaging sensor arrangement is presented in FIG. 4B as another embodiment of the present invention. The arrangement in FIG. 4B is similar to the arrangement in FIG. 4A, except for the addition of a transmission pulsing switch 8, a receiver gating switch 9, and the omission of amplifiers 62, 30 for clarity. The same components are denoted by the same reference numerals, and will not be explained again. In this configuration, the TX PULSE CONTROL signal is used to control the operation of a transmission pulsing switch 8, pulse modulating the output signal. The RX GATE CONTROL signal is used to control the operation of the receiver gating switch 9, which only allows received signals to pass through for down-conversion during specified time periods dictated by the RX GATE CONTROL signal. Through the use of this arrangement of transmit pulsing and receive signal gating, the performance of the sensor can be improved as illustrated in the signal timing example in FIG. 5.

One example of pulsed transmit and gated receiver signal timing for an imaging sensor is shown in FIG. 5 in accordance with aspects of the present invention. The timing diagram shown in FIG. 5 is meant as an example to illustrate the operation and potential benefits of pulsed transmission and gated reception, and is not meant as a limitation. In this example, during the time period τ₁, the antenna pair consisting of transmit antenna TX 1,1 and receive antenna RX 1,1 is selected by use of the signals TX_SEL and RX_SEL, followed by a pulse of the transmit signal by use of the TX PULSE CONTROL signal, and a subsequent gating of the receiver after some time delay by use of the RX GATE CONTROL signal. The gating “on” time of the receiver corresponding to the “on” state of the RX GATE CONTROL signal as shown in FIG. 5 can be matched to the transmit pulse “on” time corresponding to the “on” state of the TX PULSE CONTROL signal as shown in FIG. 5, and is configured that way for this example. Also shown in FIG. 5 is an example of the output envelope of a typical matched filter that could be utilized for filters 45, 46 in FIG. 4B in the receiver, and I and Q A/D sampling at the peak of the matched filter output envelope that could be utilized by A/D converters 340, 341 in FIG. 4B for optimal signal-to-noise-ratio performance. The pulsing of the transmit signal and gating of the received signal allows the sensor to selectively receive object returns in a range zone between a specific minimum range (Rmin) and maximum range (Rmax), related to the time delay between transmit pulse and receive gate and the time durations of each, and to reject object returns that occur at ranges less than Rmin and ranges greater than Rmax. This operation allows rejection of signals such as, but not limited to, signals coupling directly from the transmitter to the receiver, radome returns, near-field clutter, and far-field clutter. In addition, this operation can give the ability to design spatial selectivity to the range of detection for a particular application or scenario, and can be used to eliminate multi-path reflections from near-field objects. A variety of modifications can be made to the sensor timing shown in FIG. 5 by those skilled in the art, such as, but not limited to, the order of antenna pair selection or the number of transmit pulses and receive gates per antenna pair dwell time without changing the basic form or spirit of the invention.

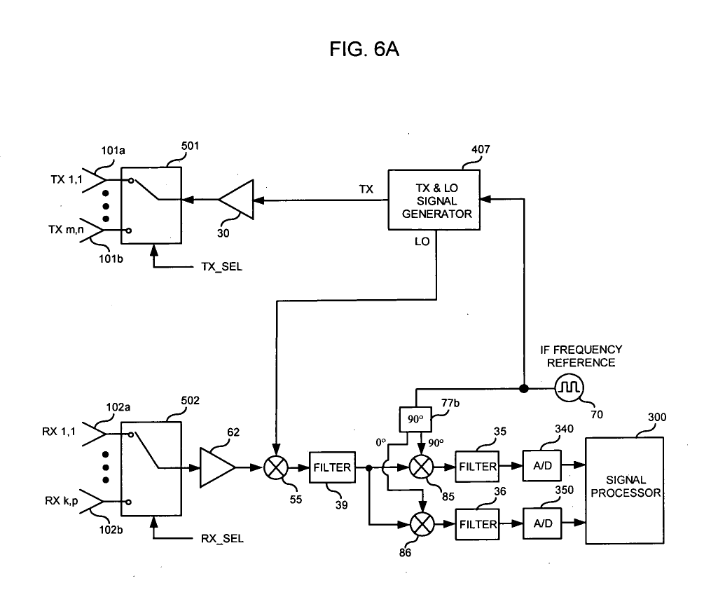

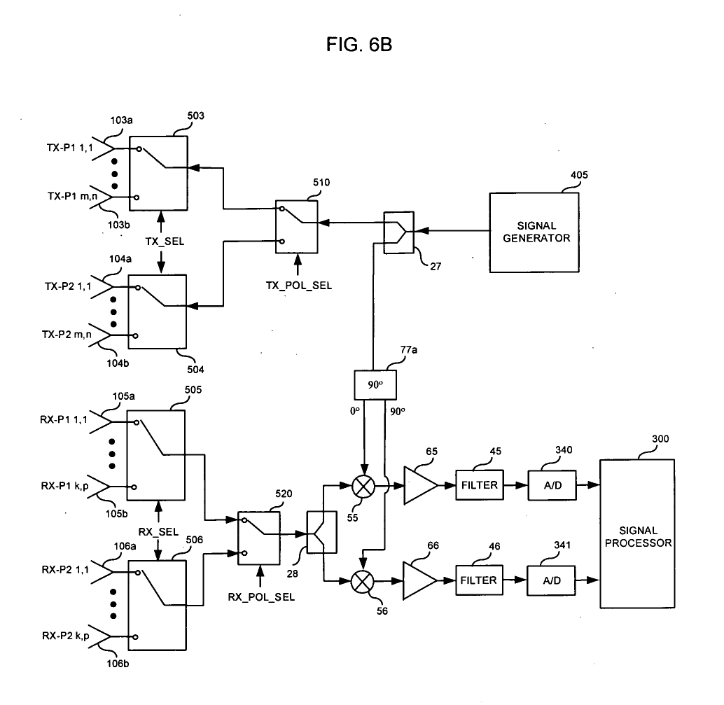

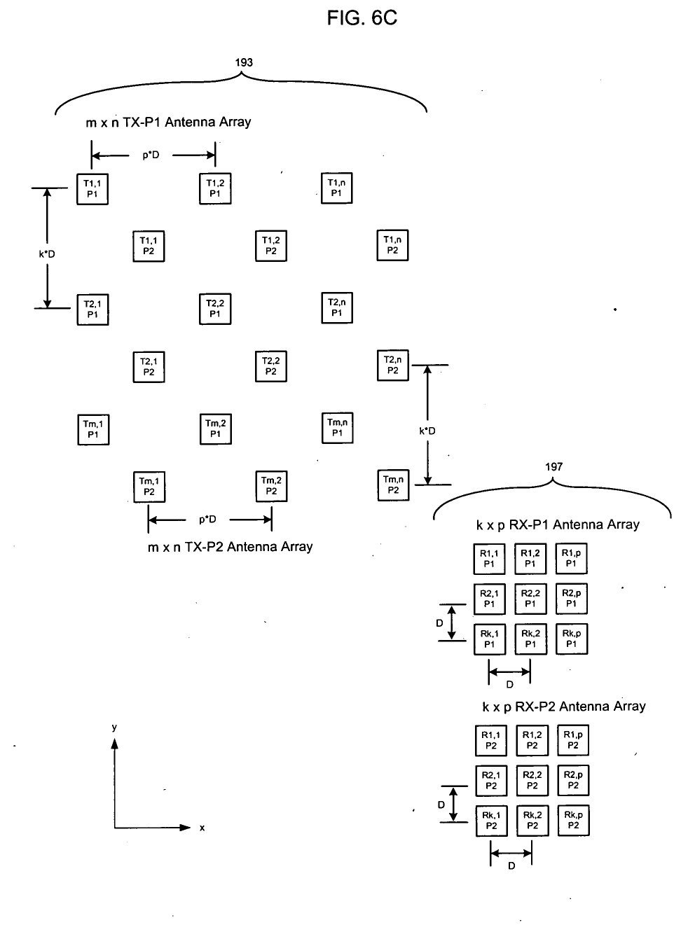

An imaging sensor arrangement is presented in FIG. 6A as a further embodiment of aspects of the present invention. The arrangement in FIG. 6A is similar to the arrangement in FIG. 4A, except for the replacement of signal generator 405 with TX & LO signal generator 407, the addition of an IF frequency reference 70, and modification of the down-conversion circuitry used to create in-phase (I) and quadrature (Q) signals prior to signal A/D conversion. The same components are denoted by the same reference numerals, and will not be explained again. In this arrangement, one signal generated by the TX & LO signal generator 407 designated by TX is fed to an amplifier 30 where it is amplified prior to transmission. The other signal generated by the TX & LO signal generator 407, designated by LO, has a frequency which is offset from the frequency of the TX signal by an amount equal to the frequency of IF frequency reference 70, and is fed to the mixer 55 where it is mixed with the received signal output from amplifier 62′. A typical frequency used for the IF frequency reference 70 can be within, but is not limited to, the frequency range of 1 MHz-500 MHz. The output signal from mixer 55 is then input to filter 39, and the output signal from filter 39 is split and input to mixers 85 and 86. One of the outputs from filter 39 is input to mixer 85, which mixes the signal with the 90-degree phase output signal from 90-degree splitter 77b, and the other output from filter 39 is input to mixer 86, which mixes the signal with the 0-degree phase output signal from 90-degree splitter 77b, creating in-phase (I) and quadrature (Q) down-converted signals. The I and Q down-converted signals are then filtered by filters 36, 35, respectively, prior to sampling by A/D converters 340, 350. The resulting sampled I and Q signals are then input to signal processor 300. Through the use of this arrangement of intermediate frequency conversion, the noise associated with the down-conversion process can be improved.

An imaging sensor arrangement is presented in FIG. 6B as a yet further embodiment of aspects of the present invention. The arrangement in FIG. 6B is similar to the arrangement in FIG. 4A, except for the replacement of selectors 501, 502 and associated antennas with polarization selectors 510, 520, antenna selectors 503, 504, 505, 506 and associated antennas 103a, 103b, 104a, 104b, 105a, 105b, 106a, 106b, and the omission of amplifiers 62, for clarity. The same components are denoted by the same reference numerals, and will not be explained again. In this arrangement, one signal from splitter 27 is input to a polarization selector 510, which outputs the signal to either selector 503 or 504 according to a control signal designated as TX_POL_SEL. The selector 503 is used to selectively connect a transmission signal to one of a plurality of antennas 103a, 103b which have a certain polarization, designated by TX-P1 1,1, TX-P1 m,n, where m and n are non-zero integers whose sum is greater than or equal to 3, for transmission in a sequential manner. The selector 504 is used to selectively connect a transmission signal to one of a plurality of an antennas 104a, 104b which have a polarization different than that of antennas 103a, 103b, designated by TX-P2 1,1, TX-P2 m,n, where m and n are non-zero integers whose sum is greater than or equal to 3, for transmission in a sequential manner. A typical frequency of the transmission signal can be within, but is not limited to, the frequency range of 1 GHz-1 THz, and can be a fixed frequency or be frequency modulated. The imaging sensor's total occupied transmit spectral bandwidth is dependent on the frequency modulation bandwidth, and can be wideband (WB) or ultra-wideband (UWB) in order to achieve adequate range resolution for some applications. A typical WB bandwidth value can be, but is not limited to, a value greater than 100 MHz. A typical UWB bandwidth value can be, but is not limited to, a value greater than 1 GHz. The arrangement of the antennas 103a, 103b can be, but is not limited to, a one-dimensional array, a two-dimensional array, a three-dimensional array, multiple one-dimensional arrays arranged in multiple axes, or a conformal array, and can have a polarization that is, but not limited to, vertical, horizontal, or circular. The arrangement of the antennas 104a, 104b can be, but is not limited to, a one-dimensional array, a two-dimensional array, a three-dimensional array, multiple one-dimensional arrays arranged in multiple axes, or a conformal array, and can have a polarization that is, but not limited to, linear, vertical, horizontal, or circular. The reflected signal from an object is received by a plurality of receive antennas 105a, 105b, designated by RX-P1 1,1, RX-P1 k,p, where k and p are non-zero integers whose sum is greater than or equal to 3, and a plurality of receive antennas 106a, 106b, designated by RX-P2 1,1, RX-P2 k,p, where k and p are non-zero integers whose sum is greater than or equal to 3. Antennas 105a, 105b have the same polarization as antennas 103a, 103b, and antennas 106a, 106b have the same polarization as antennas 104a, 104b. The arrangement of the antennas 105a, 105b can be, but is not limited to, a one-dimensional array, a two-dimensional array, a three-dimensional array, multiple one-dimensional arrays arranged in multiple axes, or a conformal array, and can have a polarization that is, but not limited to, linear, vertical, horizontal, or circular. The arrangement of the antennas 106a, 106b can be, but is not limited to, a one-dimensional array, a two-dimensional array, a three-dimensional array, multiple one-dimensional arrays arranged in multiple axes, or a conformal array, and can have a polarization that is, but not limited to, vertical, horizontal, or circular. A selector 505 is used to selectively connect one receive antenna 105a, 105b at a time with one input of polarization selector 520. A selector 506 is used to selectively connect one receive antenna 106a, 106b at a time with the other input of polarization selector 520. The polarization selector 520 is used, to selectively connect one receiver antenna of a certain polarization and a certain spatial position at a time with the receiver/down-converter circuitry for the sensor in a sequential manner. A signal designated as RX_POL_SEL controls which selector 505, 506 is selected by polarization selector 520. Through the use of this arrangement, the response of objects to signals having multiple polarizations can be sampled and utilized for image processing and/or object identification.

The block diagram shown in FIG. 6B can be modified according to aspects of the present invention. One example of such a modification, not meant as a limitation, can be for the sensor architecture to replace any or all of the selectors 503, 504, 505, 506, 510, 520 with a plurality of switched amplifiers and signal combiners, utilizing the gain/loss of the switched amplifiers to realize an antenna selection and routing function. Another example of such a modification, not meant as a limitation, can be for the sensor architecture to utilize any of the antenna networks illustrated in FIGS. 3A-C for any or both of the transmit or receive selectors and antenna functions. A further example of such a modification, not meant as a limitation, can be for the sensor architecture to use a plurality of simultaneously selected transmit signals and/or a plurality of simultaneously selected receive signals connected to a plurality of receiver/down-converters. A yet further example of such a modification, not meant as a limitation, can be for the sensor architecture to utilize antenna elements that are dual-polarized, such that selectors 503, 504 feed only one set of dual-polarized antenna elements, and selectors 505, 506 feed only one set of dual-polarized antenna elements. Another example of such a modification, not meant as a limitation, can be for the sensor architecture to share one or a plurality of antennas between transmit and receive functions. A further example of such a modification, not meant as a limitation, can be for the sensor architecture to utilize a two-stage down-conversion structure such as illustrated in FIG. 6A. A variety of amplifiers, filters, or other system elements known to those skilled in the art, such as low-noise amplifiers, power amplifiers, drivers, buffers, gain blocks, gain equalizers, logarithmic amplifiers, equalizing amplifiers, switches, and the like, can be added to or deleted from the described arrangement, or the position of existing elements may be modified, without changing the basic form or spirit of the invention.

One example of a two-dimensional, dual-polarized thinned-array is illustrated in FIG. 6C according to aspects of the present invention. The configuration shown is meant as an illustration of a dual-polarized thinned-array, not as a limitation. In this configuration, a TX arrangement 193, containing a transmit antenna array having a polarization P1 and a transmit antenna array having a polarization P2, and an RX arrangement 197, containing a receive antenna array having a polarization. P1 and a receive antenna array having a polarization P2, are positioned diagonally. The polarization P1 can be, but is not limited to, linear, vertical, horizontal, or circular. The polarization P2 can be, but is not limited to, linear, vertical, horizontal, or circular. In this arrangement, the TX arrangement 193 and RX arrangement 197 are illustrated to be diagonal to one another, where the rows of the TX arrangement 193 span a range in the x-axis that is non-overlapping with the span of the rows of the RX arrangement 197 in the x-axis, and the columns of the TX arrangement 193 span a range in the y-axis that is non-overlapping with the span of the columns of the RX arrangement 197 in the y-axis. The 3 by 3 element P1 polarized transmit and receive arrays can synthesize a 9 by 9 P1 polarized virtual array using the method described in FIGS. 2D & 2E. Similarly, the 3 by 3 element P2 polarized transmit and receive arrays can synthesize a 9 by 9 P2 polarized virtual array using the method described in FIGS. 2D & 2E. Utilizing this configuration, each virtual array can be processed separately to generate images of object responses to each of the polarizations. The digitized, down-converted signals can be utilized for object imaging, through the use of image processing techniques well known in the art such as, but not limited to, digital beam-forming (DBF) processing, super-resolution processing such as, but not limited to, the use of the multiple signal classification algorithm (MUSIC) or the estimation of signal parameters via rotational invariance techniques (ESPRIT) algorithm, spatial Fourier transform processing, two-dimensional image processing, three-dimensional image processing, two or three-dimensional image reconstruction processing, microwave or millimeter-wave holography processing, backward-wave reconstruction processing, wavefront reconstruction processing, synthetic aperture radar (SAR) processing, or Kirchoff diffraction integral processing. The example shown is meant as an illustration of a dual-polarized virtual array synthesis technique, not as a limitation. For example, not meant as a limitation, the distance between elements in each array need not be constant, but can be varied or be given multiple different values by one skilled in the art for advantage. Other array sizes and configurations can be implemented by one of ordinary skill in the art without departing from the spirit of the present invention.

According to one aspect of the present invention, the use of multiple selectable polarizations can be used for generation of object polarization signatures and utilized for object detection and/or identification purposes. According to another aspect of the present invention, the angular resolution provided by imaging techniques such as, but not limited to, digital beam-forming can provide spatial selectivity for object signatures as well as spatial rejection of other object signatures or clutter signals for improved performance and object identification capability. The object signature methods that can be used with the spatial selectivity methods described to determine the presence or identification of potential threats, weapons or contraband can include, but are not limited to, strength of returns, wideband or ultra-wideband frequency response characteristics, wideband or ultra-wideband frequency resonance characteristics, polarization response characteristics, spectral absorption characteristics, or image shape characteristics. In addition, a combination of object imaging and spatially isolated regional scanning for weapons signatures can be utilized in order to provide additional capability or performance. Furthermore, the beam-width or area of the spatially isolated regions utilized for detection of weapons signatures can be different than the resolution utilized for object imaging, and the techniques utilized for object imaging and scanning of spatially isolated regions need not be the same. For example, not meant as a limitation, a high resolution object image can be generated utilizing a two-dimensional image reconstruction technique for the purpose of providing image characteristics for image processing, while a lower resolution spatially isolated beam could be generated by a digital beam-forming process and scanned across areas of the object in order to utilize weapons signature techniques for detection and/or identification of concealed weapons. Additionally, the resolution of the image and/or the size of the spatially isolated region can be varied adaptively. Furthermore, the area of the spatially isolated region can encompass a part of an object in order to isolate weapons signatures from other parts of the object, or can encompass the entire object in order to isolate weapons signatures from the surroundings of the object.

In accordance with one aspect of the present invention, the millimeter-wave imaging techniques and/or weapons signature techniques can be combined with an image generated by another sensor such as, but not limited to, an optical wavelength camera. For example, not meant as a limitation, an optical wavelength image of an object can be enhanced by the addition of indicators added to the optical image at locations where threats or contraband is suspected to be. The indicators can include, but are not limited to, colored shapes where the color indicates threat or confidence level and/or the shape indicates type of threat, text indicating a threat type with an arrow pointing to a location on the object in the optical image, or any combination of these. One benefit of this arrangement is that the optical image can be utilized additionally for identification of the object such as, but not limited to, the identification of a person carrying the concealed threat. Another benefit of this arrangement is that if the millimeter-wave image is not shown to the operator, then privacy concerns for the individual being scanned may be avoided. Indicator types other than the ones presented can be utilized without departing from the spirit of the present invention.

Another aspect of the present invention is the utilization of the electrically sequenced or scanned virtual array arrangement for through-wall imaging. For example, not meant as a limitation, the electrically sequenced or scanned virtual array can be utilized to provide a 2D or 3D image of the interior of a room from behind a door or wall of the room. The digital lensing and image reconstruction methods can be adapted to additionally compensate for the characteristics of the medium of the wall or door though which the electro-magnetic waves propagate.

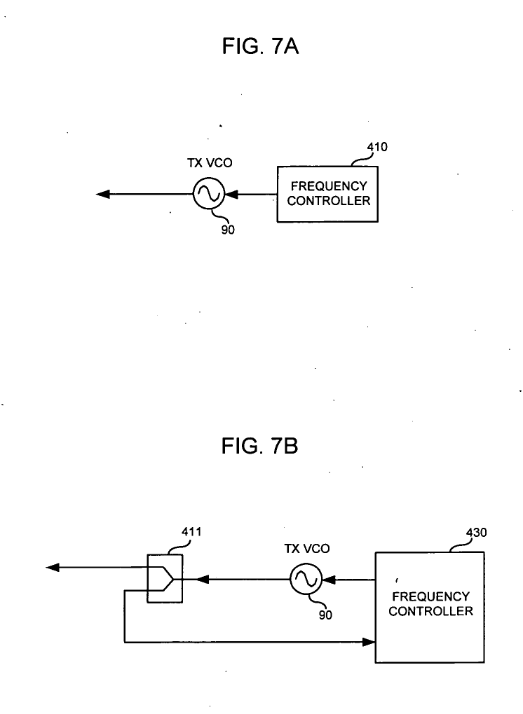

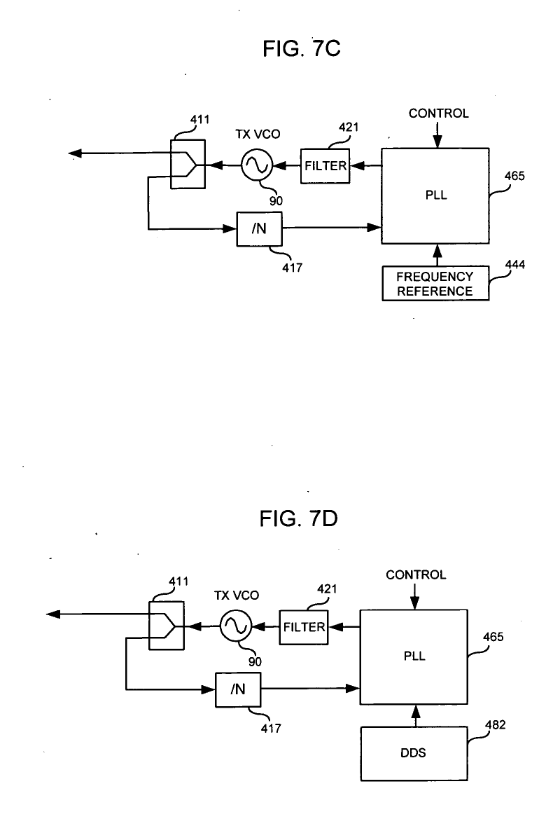

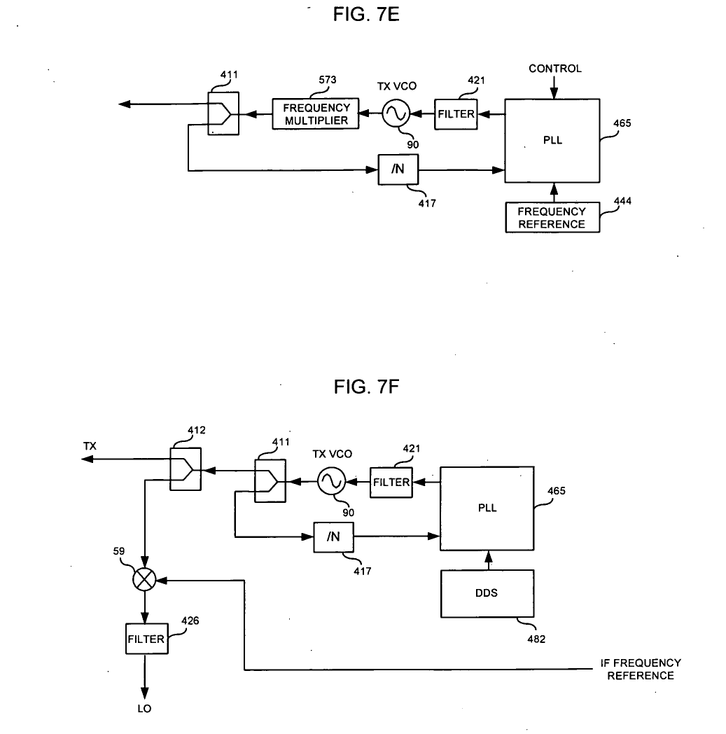

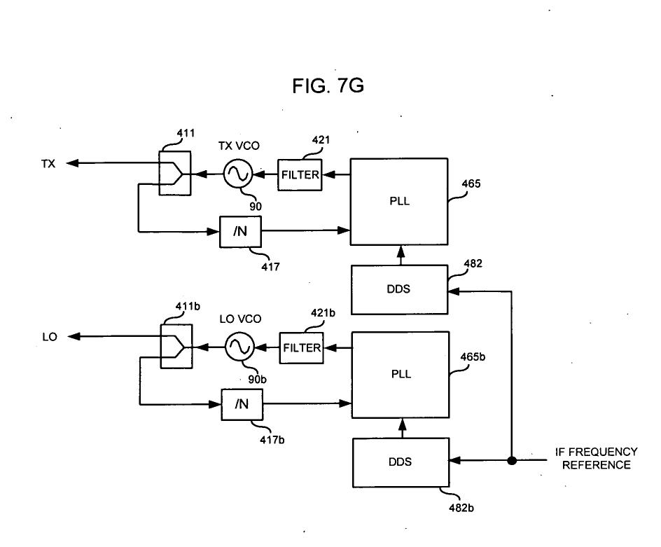

One embodiment of signal generator 405 is shown in FIG. 7A. In this configuration, a frequency controller 410 controls the frequency of a transmit voltage-controlled-oscillator 90. The embodiment shown in FIG. 7A represents an open-loop transmit signal generator configuration. The configuration shown is meant as an illustration of a transmit signal generation technique, not as a limitation. Other open-loop signal generation techniques can be implemented by one of ordinary skill in the art without departing from the spirit of the present invention.

Another embodiment of signal generator 405 is shown in FIG. 7B. In this configuration, the output of a frequency controller 430 controls the frequency of a transmit voltage-controlled-oscillator 90. The output signal from the transmit voltage-controlled-oscillator 90 is split by signal splitter 411, where one portion of the signal is output, and the other portion of the signal is fed back to the frequency controller 430, where it is used to monitor and adjust the frequency of the transmit voltage-controlled-oscillator 90, forming a closed-loop transmit signal generator.

A further embodiment of signal generator 405 is shown in FIG. 7C. In this configuration, the output of a phase-locked loop (PLL) 465 is filtered by loop filter 421 and used to control the frequency of a transmit voltage-controlled-oscillator (TX VCO) 90. The PLL 465 can be implemented by, but is not limited to, a phase detector, phase-frequency detector, integer-N PLL, or fractional-N PLL. The output from TX VCO 90 is split by splitter 411, where one portion of the signal is output and the other portion of the signal is frequency divided by N by divider 417, where N is an integer greater than 1, and fed back to the PLL 465 forming a closed-loop transmit signal generator. A frequency reference 444 is input to the PLL 465, and the PLL 465 can be controlled by an external control signal if required.

A yet further embodiment of signal generator 405 is shown in FIG. 7D. In this configuration, the output of a PLL 465 is filtered by loop filter 421 and used to control the frequency of a transmit voltage-controlled-oscillator (TX VCO) 90. The output from TX VCO 90 is split by splitter 411, where one portion of the signal is output and the other portion of the signal is frequency divided by N by divider 417, where N is an integer greater than 1, and fed back to the PLL 465 forming a closed-loop transmit signal generator. A direct-digital-synthesizer (DDS) 482 is input as a frequency reference to the PLL 465. Through the control of the output frequency of the DDS 482, the frequency of the TX VCO 90 can be controlled.

Another embodiment of signal generator 405 is shown in FIG. 7E. The arrangement in FIG. 7E is similar to the arrangement in FIG. 7C, except for the use of a frequency multiplier 573 at the output of transmit voltage-controlled-oscillator (TX VCO) 90. The same components are denoted by the same reference numerals, and will not be explained again. The use of a frequency multiplier 573 allows the frequency of TX VCO 90 to be lower than the output transmit frequency of the signal generator 405.

The arrangement shown in FIG. 7E can be modified according to aspects of the present invention. One example of such a modification, not meant as a limitation, can be for the frequency reference 444 to be replaced by a DDS 482, such as described in the arrangement of FIG. 7D. Other modifications can be implemented by one of ordinary skill in the art without departing from the spirit of the present invention.

One embodiment of TX & LO signal generator 407 is shown in FIG. 7F. In this configuration, the output of a PLL 465 is filtered by loop filter 421 and used to control the frequency of a transmit voltage-controlled-oscillator (TX VCO) 90. The output from TX VCO 90 is split by splitter 411, where one portion of the signal is fed to splitter 412, while the other portion of the signal is frequency divided by N by divider 417, where N is an integer greater than 1, and fed back to the PLL 465 forming a closed-loop transmit signal generator. A direct-digital-synthesizer (DDS) 482 is input as a frequency reference to the PLL 465. Through the control of the output frequency of the DDS 482, the frequency of the TX VCO 90 frequency can be controlled. The output from splitter 411 is split by splitter 412, where one portion of the signal is output as the signal designated by TX, while the other portion of the signal is fed to mixer 59, where it is mixed with an IF frequency reference signal. The output from mixer 59 is filtered by filter 426 and output as the signal designated by LO.

Another embodiment of TX & LO signal generator 407 is shown in FIG. 7G. In this configuration, the output of a PLL 465 is filtered by loop filter 421 and used to control the frequency of a transmit voltage-controlled-oscillator (TX VCO) 90. The output from TX VCO 90 is split by splitter 411, where one portion of the signal is output as the signal designated by TX, and the other portion of the signal is frequency divided by N by divider 417, where N is an integer greater than 1, and fed back to the PLL 465 forming a closed-loop transmit signal generator. A direct-digital-synthesizer (DDS) 482 is input as a frequency reference to the PLL 465. An IF frequency reference is input to the DDS 482 as a frequency reference for the DDS. A second PLL 465b is filtered by loop filter 421b and used to control the frequency of a local oscillator voltage-controlled-oscillator (LO VCO) 90b. The output from LO VCO 90b is split by splitter 411b, where one portion of the signal is output as the signal designated by LO, while the other portion of the signal is frequency divided by N by divider 417b, where N is an integer greater than 1, and fed back to the PLL 465b forming a closed-loop local oscillator signal generator. A direct-digital-synthesizer (DDS) 482b is input as a frequency reference to the PLL 465b. An IF frequency reference is input to the DDS 482b as a frequency reference for the DDS. The DDS 482b is programmed to have a frequency offset from the DDS 482 such that the TX output signal and LO output signal are offset in frequency an amount equal to the IF frequency reference frequency.

The embodiments shown in FIGS. 7A-G represent examples of signal generation configurations. The configurations shown are meant as an illustration of signal generation techniques, not as a limitation. Other signal generation techniques can be implemented by one of ordinary skill in the art without departing from the spirit of the present invention.

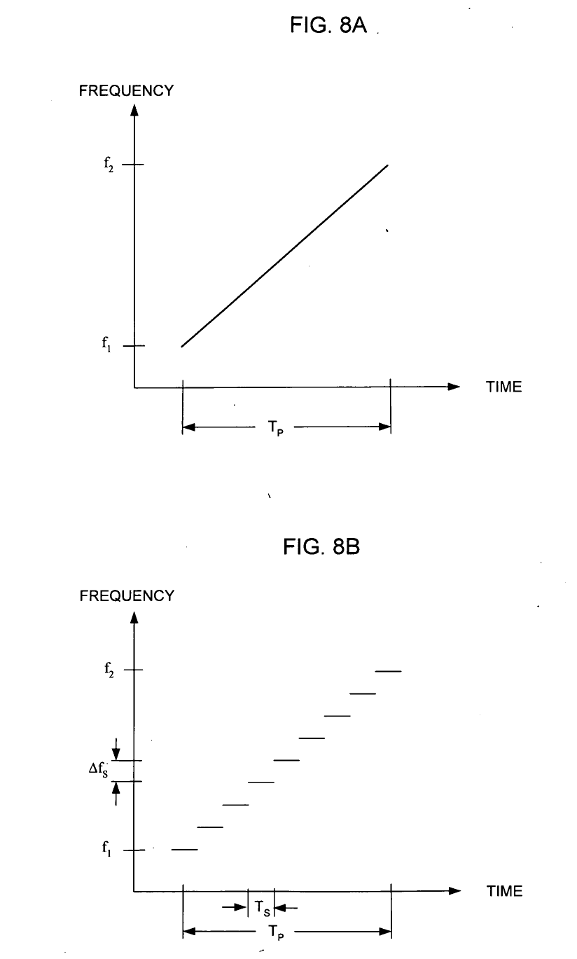

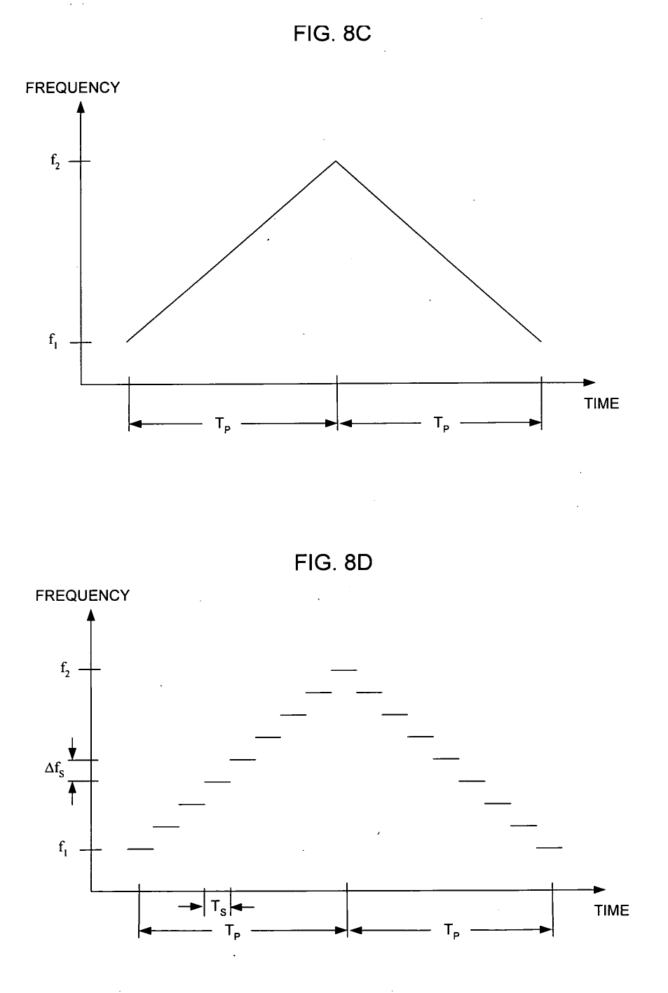

FIG. 8A illustrates a linearly frequency-modulated waveform for use in the transmit signal generator 650, signal generator 405 or TX & LO signal generator 407 according to aspects of the present invention. This waveform shows a linearly modulated frequency with a period equal to Tp. This waveform shown is an example of linear frequency modulation and is not meant as a restriction. The waveform can also comprise, but is not limited to, a repeating pattern of linearly increasing frequency ramps, a repeating pattern of linearly decreasing frequency ramps, or alternating periods of linearly increasing and decreasing frequency ramps. Also, periods where the frequency modulation is stopped may be inserted into the abovementioned patterns. Furthermore, in order to achieve adequate range resolution for some applications, the total frequency modulation bandwidth, defined as |f₂−f₁| in FIG. 8A, can be wideband (WB) or ultra-wideband (UWB).

Using the frequency modulation waveform described in FIG. 8A, object range information may be calculated from the down-converted signals of the architectures shown in FIGS. 1A-C, FIGS. 4A-B and FIGS. 6A-B in the following way. Peaks in the down-converted signal spectrum represent returns from objects within the field of view. The frequency of the peaks is proportional to object range and is used to calculate object range. As an example, not meant as a limitation, let the arrangement of FIG. 4A utilize a linearly increasing frequency modulation as shown in FIG. 8A. Let the down-converted signal be sampled & measured during each coherent measurement interval T_{P}. Under these conditions, object range can be calculated by the following equation:

$$R = \frac{c \cdot {T}_{P}}{2 \cdot ( {f}_{2} - {f}_{1} )} \cdot ( {f}_{B} ) \qquad ( 1 )$$

where R is the calculated object range, c is the speed of light in a vacuum, f₂ is the maximum frequency of the linear modulation, f₁ is the minimum frequency of the linear modulation, and f_{B} is the beat frequency in the down-converted signal corresponding to measurements during the coherent measurement interval T_{P}. The object range data calculated using this method can be utilized to generate three-dimensional object images through use with methods well known in the art, such as, but not limited to, digital beam-forming angular processing or super-resolution angular processing.

Another approach to calculating object range data is to use an inverse fast Fourier transform (IFFT) or inverse discrete Fourier transform (IDFT), after sampling the down-converted signal, to build an object return range profile. The peaks in the IFFT or IDFT profile represent object returns with range proportional to the peak's associated time bin. The object range data calculated using this method can be utilized to generate three-dimensional object images through use with methods well known in the art, such as, but not limited to, digital beam-forming angular processing or super-resolution angular processing, which will be described in more detail in the following text.

FIG. 8B illustrates a stepped frequency modulation waveform for use in the transmit signal generator 650, signal generator 405 or TX & LO signal generator 407 according to aspects of the present invention. This waveform shows a linearly stepped frequency pattern with a frequency increasing step sequence period equal to T_{P}. This waveform shown is an example of linearly stepped frequency modulation and is not meant as a restriction. A typical value of Δf_{S} can be within, but is not limited to, the range of 100 KHz-100 MHz. A typical value of T_{S} can be within, but is not limited to, the range of 500 nanoseconds (ns)-20 microseconds (μs). The waveform can also comprise, but is not limited to, a repeating pattern of linearly increasing frequency steps, a repeating pattern of linearly decreasing frequency steps, or alternating periods of linearly increasing and decreasing frequency step patterns. Also, periods where the stepped frequency modulation pattern is stopped may be inserted into the abovementioned patterns. In addition, the value of T_{S} may be varied or dithered, or the linearity of the frequency steps with respect to time may be varied by one skilled in the art without departing from the spirit of the present invention. Furthermore, in order to achieve adequate range resolution for some applications, the total frequency modulation bandwidth, defined as |f₂−f₁| in FIG. 8B can be wideband (WB) or ultra-wideband (UWB).

Using the frequency modulation waveform described in FIG. 8B, object range information may be calculated from the down-converted signals of the architectures shown in FIGS. 1A-C, FIGS. 4A-B and FIGS. 6A-B in the following way. Peaks in the down-converted signal spectrum represent returns from objects within the field of view. The frequency of the peaks is proportional to object range and is used to calculate object range. As an example, not meant as a limitation, let the arrangement of FIG. 4A utilize a linearly increasing frequency step sequence as shown in FIG. 8B. Let the down-converted signal be sampled & measured during each coherent measurement interval T_{P}, which for this example also corresponds to the frequency-modulated step sequence period. Under these conditions, object range can be calculated by the following equation:

$$R = \frac{c \cdot {T}_{S}}{2 \cdot Δ {f}_{S}} \cdot ( {f}_{B} ) \qquad ( 2 )$$

where R is the calculated object range, c is the speed of light in a vacuum, T_{S} is dwell time of each frequency step, Δf_{S} is the difference between adjacent frequency step values in the linear step sequence, and f_{B} is the beat frequency in the down-converted signal corresponding to measurements during the frequency-stepped sequence period T_{P}. The object range data calculated using this method can be utilized to generate three-dimensional object images through use with methods well known in the art, such as, but not limited to, digital beam-forming angular processing or super-resolution angular processing.

Another approach to calculating object range data is to use an inverse fast Fourier transform (IFFT) or inverse discrete Fourier transform (IDFT), after sampling the down-converted signal, to build an object return range profile. The peaks in the IFFT or IDFT profile represent object returns with range proportional to the peak's associated time bin. The object range data calculated using this method can be utilized to generate three-dimensional object images through use with methods well known in the art, such as, but not limited to, digital beam-forming angular processing or super-resolution angular processing which will be described in more detail in the following text.

FIG. 8C illustrates a multiple-slope, linearly frequency-modulated waveform for use in the transmit signal generator 650, signal generator 405 or TX & LO signal generator 407 according to aspects of the present invention. This waveform shows a linear up-slope frequency modulation during a first time period Tp, and a linear down-slope frequency modulation during a second time period Tp. This waveform shown is an example of frequency modulation, and is not meant as a restriction. A typical value of Tp can be within, but is not limited to, the range of 100 microseconds (μs)-100 milliseconds (ms). The frequency modulation can also consist of, but is not limited to, a repeating pattern of linear up-slope modulation, a repeating pattern of linear down-slope modulation, an alternating pattern of up- and down-slope modulation, a monotonically increasing frequency over a time period, a monotonically decreasing frequency over a time period, or an alternating pattern of monotonically increasing and decreasing frequency modulation. In addition, one or more blanking periods where the frequency is constant may be inserted within or between the up or down slope periods. Furthermore, in order to achieve adequate range resolution for some applications, the total frequency modulation bandwidth, defined as |f₂−f₁| in FIG. 8C can be wideband (WB) or ultra-wideband (UWB).

Using the frequency modulation waveform described in FIG. 8C, object information may be calculated from the down-converted signals of the architectures shown in FIGS. 1A-C, FIGS. 4A-B and FIGS. 6A-B in the following way. Peaks in the down-converted signal spectrum represent object returns. The frequency of the peaks is proportional to object range, and is used to calculate object range. As an example, not meant as a limitation, let the sensor arrangement of FIG. 4A utilize a frequency modulation according to FIG. 8C. Let the down-converted signal be sampled & measured during each coherent measurement interval T_{P}, which also corresponds in this example to the frequency up-ramp and down-ramp periods. Under these conditions, object range can be calculated by the following equation:

$$R = \frac{c \cdot {T}_{P}}{4 \cdot Δ {f}_{BW}} \cdot ( {f}_{U} + {f}_{D} ) \qquad ( 3 )$$

where R is the calculated object range, c is the speed of light in a vacuum, T_{P} is the period of the up-ramp or down-ramp of the frequency modulation, Δf_{BW} is the total frequency excursion during the coherent measurement interval T_{P} which is equal to |f₂−f₁| in FIG. 8C, and f_{U} and f_{D} are the beat frequencies in the down-converted signal corresponding to measurements during the frequency up-ramp and frequency down-ramp periods Tp respectively.

The Doppler frequency shift of the frequency peaks measured across the down-converted signal spectrum is used to calculate object relative velocity. As an example, not meant as a limitation, let the sensor arrangement of FIG. 4A utilize a frequency modulation according to FIG. 8C. Let the down-converted signal be sampled and measured during each coherent measurement interval T_{P}, which also corresponds in this example to the frequency up-ramp and down-ramp periods. Under these conditions, object relative velocity can be calculated by the following equation:

$$V = \frac{c \cdot ( {f}_{D} - {f}_{U} )}{4 \cdot {f}_{0}} \qquad ( 4 )$$

where V is the calculated object relative velocity defined as positive for an approaching target, c is the speed of light in a vacuum, f_{U} and f_{D} are the beat frequencies in the down-converted signal corresponding to measurements during the frequency up-ramp and frequency down-ramp modulation intervals T_{P} respectively, and f₀ is the average frequency of the transmitted signal during a coherent measurement period T_{P}.

FIG. 8D illustrates a stepped frequency modulation waveform for use in the transmit signal generator 650, signal generator 405 or TX & LO signal generator 407 according to aspects of the present invention. This waveform shows a linearly stepped frequency pattern with a frequency increasing step sequence period and decreasing step sequence period each equal to Tp. This waveform shown is an example of linearly stepped frequency modulation and is not meant as a restriction. A typical value of Δf_{S} can be within, but is not limited to, the range of 100 KHz-100 MHz. A typical value of T_{S} can be within, but is not limited to, the range of 500 nanoseconds (ns)-20 microseconds (μs). The waveform can also comprise, but is not limited to, a repeating pattern of linearly increasing frequency steps, a repeating pattern of linearly decreasing frequency steps, or alternating periods of linearly increasing and decreasing frequency step patterns. Also, periods where the stepped frequency modulation pattern is stopped may be inserted into the abovementioned patterns. In addition, the value of T_{S} may be varied or dithered, or the linearity of the frequency steps with respect to time may be varied by one skilled in the art without departing from the spirit of the present invention. Furthermore, in order to achieve adequate range resolution for some applications, the total frequency modulation bandwidth, defined as |f₂−f₁| in FIG. 8D can be wideband (WB) or ultra-wideband (UWB).

Using the frequency modulation waveform described in FIG. 8D, object information may be calculated from the down-converted signals of the architectures shown in FIGS. 1A-C, FIGS. 4A-B and FIGS. 6A-B in the following way. Peaks in the down-converted signal spectrum represent object returns. The frequency of the peaks is proportional to object range and is used to calculate object range. As an example, not meant as a limitation, let the sensor arrangement of FIG. 4A utilize a linearly increasing frequency step sequence and linearly decreasing frequency step sequence as shown in FIG. 8D. Let the down-converted signal be sampled and measured during each coherent measurement interval T_{P}, which for this example also corresponds to the frequency increasing step sequence period and decreasing step sequence period. Under these conditions, object range can be calculated by the following equation:

$$R = \frac{c \cdot {T}_{S}}{4 \cdot Δ {f}_{S}} \cdot ( {f}_{U} + {f}_{D} ) \qquad ( 5 )$$

where R is the calculated object range, c is the speed of light in a vacuum, T_{S} is dwell time of each frequency step, Δf_{S} is the difference between adjacent frequency step values in the linear step sequence, and f_{U} and f_{D} are the beat frequencies in the down-converted signal corresponding to measurements during the frequency increasing sequence and frequency decreasing sequence periods T_{P}, respectively.

The Doppler frequency shift of the frequency peaks measured across the down-converted signal spectrum is used to calculate object relative velocity. As an example, not meant as a limitation, let the sensor arrangement of FIG. 4A utilize a linearly increasing frequency step sequence and linearly decreasing frequency step sequence as shown in FIG. 8D. Let the down-converted signal be sampled once per frequency step in each sequence, and measured during each coherent measurement interval T_{P}, which for this example also corresponds to the frequency increasing step sequence period and decreasing step sequence period. Under these conditions, object relative velocity can be calculated by the following equation:

$$V = \frac{c}{2 \cdot ( {f}_{1} + {f}_{2} )} \cdot ( {f}_{D} - {f}_{U} ) \qquad ( 6 )$$

where V is the calculated object relative velocity defined as positive for an approaching target, c is the speed of light in a vacuum, f₁ and f₂ are the minimum and maximum frequency steps in the linear sequence during a coherent measurement period T_{P}, and f_{U} and f_{D} are the beat frequencies in the digitized down-converted signal corresponding to the measurements during the frequency up-step sequence and down-step sequence periods T_{P}, respectively.

Object velocity information can be utilized in a variety of applications according to aspects of the present invention. One application, not meant as a limitation, is to utilize the velocity information of an object in conjunction with its positional information to determine the threat potential for purposes such as, but not limited to, deployment of countermeasures. Another application, not meant as a limitation, is to determine if there is object motion as part of a security system.

An alternate way to utilize the frequency-modulated data is with three-dimensional image reconstruction techniques well known in the art. According to these techniques, the data sampled at different frequencies is utilized to reconstruct a three-dimensional rendered image using an algorithm such as, but not limited to, a backward-wave reconstruction technique.

Another way to utilize the frequency-modulated data is with two-dimensional image reconstruction techniques well known in the art for each frequency step in the sequence, then average or combine the two-dimensional rendered images to improve the image characteristics such as, but not limited to, reduction of speckle or noise in the image.

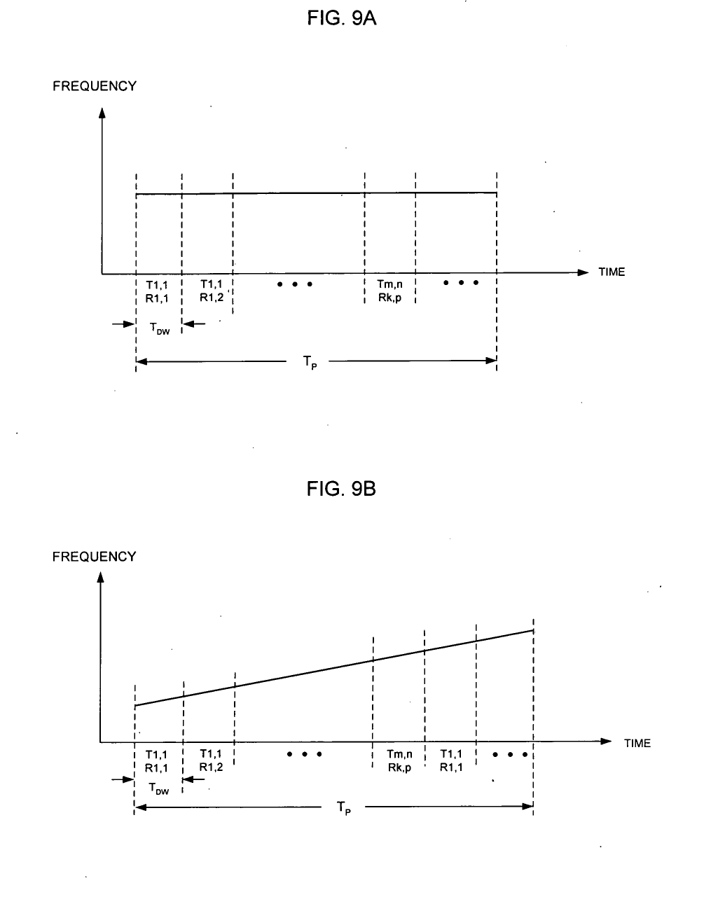

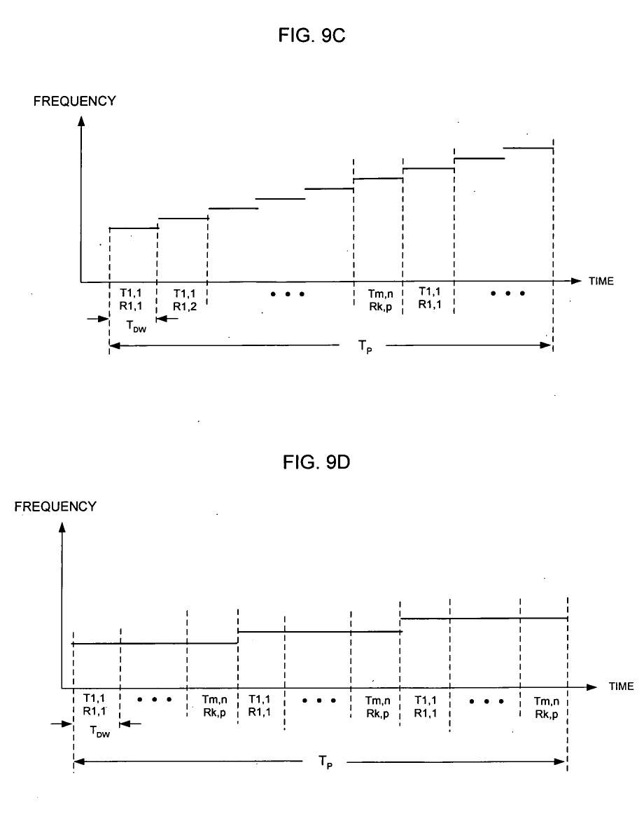

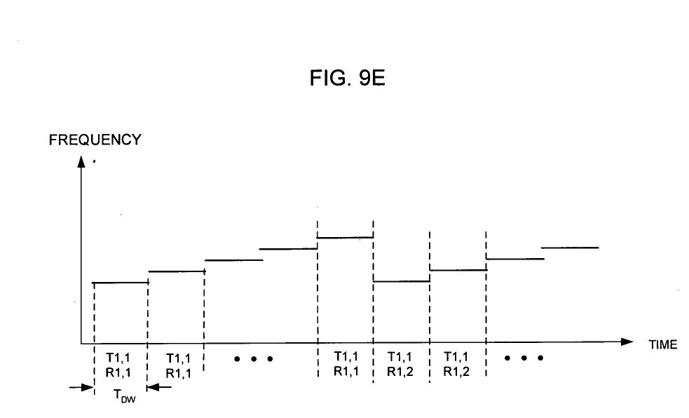

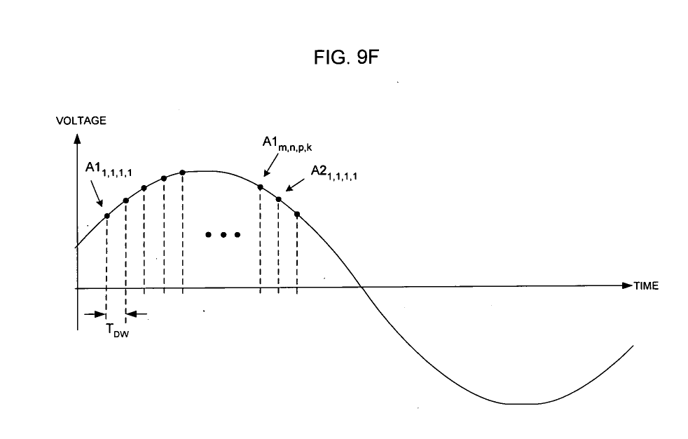

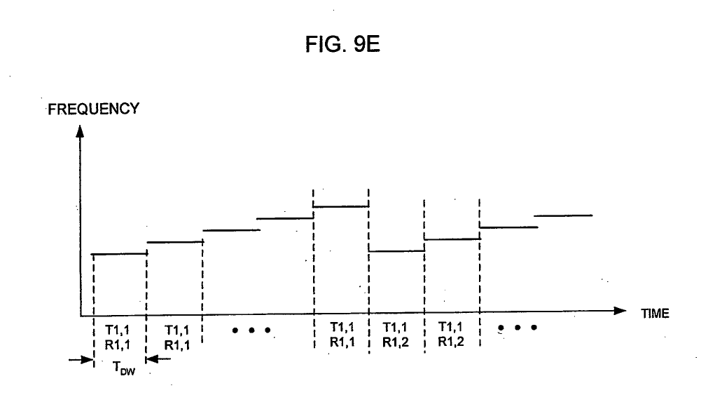

FIG. 9A illustrates an example of timing of thinned-array antenna selection for use with a fixed transmission frequency according to aspects of the present invention. According to this example, unique combinations of transmit and receive antennas in the thinned-array architecture are each selected for a period of time designated by T_{DW}, during which the down-converted signal is sampled and stored. In this example, not meant as a limitation, the transmit array consists of m by n elements, and the receive array consists of k by p elements, where m and n are non-zero integers whose sum is greater than or equal to 3, and k and p are non-zero integers whose sum is greater than or equal to 3. A typical value of T_{DW} can be within, but is not limited to, the range of 100 nanoseconds (ns)100 microseconds (μs). After all unique combinations of transmit and receive elements are sequenced through, the sequence is repeated for the duration of the coherent processing time period T_{P}. The stored digital samples of the down-converted signals during this period Tp are grouped separately for each unique combination of transmit and receive antennas to create a sequence of time-ordered samples of the down-converted signals for each synthesized array element spatial position, and will be utilized for image processing. Alternately, a sequence of samples can be taken for each unique antenna combination period of time T_{DW} before switching to the next unique antenna combination without departing from the present invention.

FIG. 9B illustrates another example of timing of thinned-array antenna selection for use with a linearly frequency-modulated waveform according to aspects of the present invention. According to this example, unique combinations of transmit and receive antennas in the thinned array architecture are each selected for a period of time denoted T_{DW}, during which the down-converted signal is sampled and stored. In this example, not meant as a limitation, the transmit array consists of m by n elements, and the receive array consists of k by p elements, where m and n are non-zero integers whose sum is greater than or equal to 3, and k and p are non-zero integers whose sum is greater than or equal to 3. A typical value of T_{DW} can be within, but is not limited to, the range of 100 nanoseconds (ns)-100 microseconds (is). After all unique combinations of transmit and receive elements are sequenced through, the sequence is repeated for the duration of the coherent processing time period T_{P} of the linearly frequency-modulated waveform. The stored digital samples of the down-converted signals during this period T_{P} are grouped separately for each unique combination of transmit and receive antennas to create a sequence of time ordered samples of the down-converted signals for each synthesized array element spatial position, and will be utilized for image processing. Alternately, the entire linear frequency modulation can be performed and a sequence of samples can be taken for each unique antenna combination period of time T_{DW} and the linear frequency modulation repeated for the next unique antenna combination without departing from the present invention.

FIG. 9C illustrates a further example of timing of thinned-array antenna selection for use with a linearly frequency stepped modulation waveform according to aspects of the present invention. According to this example, unique combinations of transmit and receive antennas in the thinned array architecture are each selected for a period of time denoted T_{DW}, during which the down-converted signal is sampled and stored. In this example, not meant as a limitation, the transmit array consists of m by n elements, and the receive array consists of k by p elements, where m and n are non-zero integers whose sum is greater than or equal to 3, and k and p are non-zero integers whose sum is greater than or equal to 3. A typical value of T_{DW} can be within, but is not limited to, the range of 100 nanoseconds (ns)-100 microseconds (μs). After all unique combinations of transmit and receive elements are sequenced through, the sequence is repeated for the duration of the coherent processing time period T_{P} of the stepped frequency modulation waveform. The stored digital samples of the down-converted signals during this period T_{P} are grouped separately for each unique combination of transmit and receive antennas to create a sequence of time ordered samples of the down-converted signals for each synthesized array element spatial position, and will be utilized for image processing.

FIG. 9D illustrates a yet further example of timing of antenna selection for use with a linearly frequency stepped modulation waveform, compatible with image processing methods according to aspects of the present invention. This example is similar to that illustrated in FIG. 9C, with the exception that the entire set of unique combinations of transmit and receive antennas in the thinned array architecture is sequentially selected and corresponding down-converted signals sampled during each step of the frequency stepped waveform.

FIG. 9E illustrates another example of timing of antenna selection for use with a linearly frequency stepped modulation waveform, compatible with image processing methods according to aspects of the present invention. This example is similar to that illustrated in FIG. 9C, with the exception that the entire stepped-frequency waveform is repeated for each time period T_{DW} for each unique combination of transmit and receive antennas in the thinned array architecture.

FIG. 9F illustrates an example of a down-converted object return signal and A/D sample timing consistent with the stepped frequency modulation waveform and receiver antenna sequencing method described in FIG. 9C. The A/D sample values of the down-converted signal are illustrated by the black dots superimposed on the signal, and are labeled Aj_{m,n,p,k}, where j is an integer representing the sample number for each of the unique transmit and receive antenna combinations, m and n represent the transmit antenna element index m,n, and p and k represent the receive antenna element index p,k. As can be seen, each successive A/D sample is delayed in time with respect to the preceding A/D sample by a time equal to T_{DW}, and occurs at a different phase on the down-converted object return signal. For image processing methods that utilize complex signal phase, it is advantageous to utilize digitized down-converted signals which have the difference in A/D sample timing between them compensated. The difference in sample timing can be compensated for in the complex frequency domain as a frequency-dependent phase shift. As an example, let each digitized sample sequence Ai_{m,n,p,k} of the down-converted signals during the period T_{P} be grouped separately for each corresponding unique transmit and receive antenna combination and ordered in time. Let each separate N-sample sequence be processed separately by an N-point complex FFT. The difference in sample timing between each antenna combination's FFT sequence can be compensated by applying the phase shift in the following equation to the complex frequency points in the FFT sequence:
ΔΨⱼ=2π·fⱼ·ΔTₖ (7)
where ΔΨⱼ is the complex phase shift to be applied the jth complex FFT point, fⱼ is the frequency of the jth position in the FFT sequence, j is an integer between 1 and N−1 for an N-point FFT sequence, and ΔTₖ is the difference in time between the A/D samples in the N-sample sequence.

According to one aspect of the present invention, the digital beam-forming (DBF) method is presented as one method of image processing. The digital beam-forming method is adapted for use with the architectures illustrated in FIGS. 1A-C, FIGS. 4A-B and FIGS. 6A-B utilizing the digitized fast Fourier transformed (FFT) phase-corrected sequences for each unique combination of transmit and receive antennas in the thinned array architecture, which represent the spatial positions in the synthesized array. Once an FFT sequence is obtained for each element in this synthesized array, a multitude of array gain patterns can be generated from this set of data, and target range can be determined from the Fourier transform profiles calculated for each. One method of digital beam-forming signal processing is to generate array gain beam-patterns through combining of digitally phase shifted or digitally phase shifted and amplitude scaled complex FFT data from each synthesized array spatial position. One method of imaging an object is through scanning of these generated beam patterns across the field of view for each range bin, creating a three-dimensional rendering of the object or objects in the field of view.

According to another aspect of the present invention, a super-resolution processing method is presented as another method of image processing. The super-resolution processing method is adapted for use with the architectures illustrated in FIGS. 1A-C, FIGS. 4A-B and FIGS. 6A-B utilizing the digitized fast Fourier transformed (FFT) phase-corrected sequences for each of the synthesized antenna positions. In this method, a super-resolution algorithm is used to process the phase of the complex sampled signals. As an example, for a synthesized line-array of k antenna elements, the relation of the phase difference between antenna elements and angular direction of object returns can be expressed by the following equation:
θⱼ=arcsin [ΔΨ_{j,b,g}·λ(2·π˜D_{b,g})] (8)
where θⱼ is the direction from boresight in the axis of the array elements of the j^{th} object return, ΔΨ_{j,b,g} is the phase difference corresponding to the j^{th} object return between synthesized antenna spatial positions b and g, D_{b,g} is the distance separating synthesized receive antenna positions b and g in the axis in which target direction θ is to be determined, λ is the average wavelength of the transmitted waveform during a coherent measurement interval, k is an integer greater than or equal to 3, b is an integer greater than 1 and less than or equal to k+1, and g is an integer greater than 0 and less than or equal to k. Since phase differences between receive antenna positions are preserved after down-conversion, the phase differences between the down-converted difference signals corresponding to the synthesized receive antenna positions can be used for ΔΨ. The set of phase measurements between a plurality of synthesized antenna spatial positions can be used as inputs to a super-resolution algorithm, which outputs the maximum likelihood of object return angular positions based upon the set of input data. Furthermore, a super-resolution algorithm has the ability to provide angular resolution of object returns within the field of view. One super-resolution algorithm well known in the art is the multiple signal classification algorithm (MUSIC). Another super-resolution algorithm well known in the art is the estimation of signal parameters via rotational invariance techniques (ESPRIT).

Although the preceding examples have illustrated one-dimensional and two-dimensional antenna array arrangements, the concepts and methods described can be extended to multi-dimensional arrays such as, but not limited to, multiple one-dimensional arrays arranged in multiple axes, orthogonal line-arrays, conformal arrays or three-dimensional arrays by one skilled in the art without departing from the spirit of the present invention. Also, although the preceding examples illustrate the use of switching elements to sequentially switch between antenna elements in an array to minimize hardware and cost, multiple parallel receive down-conversion channels can be utilized, as well as combinations of parallel and sequential operation as part of the present invention.

Additionally, according to aspects of the present invention, a method can be utilized whereby a coarse, lower-resolution imaging mode is used to determine the location of an object rapidly, and a higher-resolution imaging mode is utilized to analyze the object. One way this can be achieved is to utilize a lower number of antenna array elements, or a sub-array of elements, for the lower-resolution imaging to determine the location of objects, and to utilize a higher number of array elements for the higher-resolution imaging where objects are determined to be located. One benefit of such a method can be to reduce the time and processing required to scan an area or volume of space.

Additionally, according to aspects of the present invention, a method can be utilized whereby two or more sensors are utilized to image a common area or volume, and the sensors are synchronized such that only one sensor transmits at a time. Utilizing this method, the images from each sensor can be integrated into a common multi-dimensional view of the common area or volume.

Furthermore, according to aspects of the present invention, a method is presented whereby the imaging sensor can be utilized to determine if a further action by another sensor or system is deployed. One example, not meant as a limitation, utilizes the imaging sensor to determine the location where a second type of sensor such as, but not limited to, an optical imager or camera should focus. One way the sensor can be utilized is for, but not limited to, detection of movement of one or more objects within the field of view. Another example, not meant as a limitation, utilizes the imaging sensor to determine if an object is a threat whereby a countermeasures system can be deployed.

The preceding concepts, methods, and architectural elements described are meant as illustrative examples of aspects of the present invention, not as a limitation. Different combinations of these concepts, methods, and architectural elements than that described in the preceding figures can be utilized by one of ordinary skill in the art without departing from the spirit of the present invention.

While certain exemplary embodiments have been described and shown in the accompanying drawings, it is to be understood that such embodiments are merely illustrative of and not restrictive on the broad invention, and that this invention not be limited to the specific constructions and arrangements shown and described, since various other modifications may occur to those ordinarily skilled in the art.

What is claimed is:

1. An antennae system for a detector, comprising:
a two-dimensional electro-magnetic transmitter array that includes an x number of transmitter elements; and,
a two-dimensional electro-magnetic receiver array that includes a y number of receiver elements, said two-dimensional electro-magnetic transmitter and receiver arrays having a spatial relationship such that at least one subset of said two-dimensional electro-magnetic transmitter and receiver arrays forms a regular array of spatial displacements of z pairwise combinations of transmitter and receiver elements, where z is greater than the sum of x and y.

2. The system of claim 1, wherein said elements of said two-dimensional electro-magnetic transmitter array have a spacing along at least one dimension that is a multiple integer of a similar spacing between elements of said two-dimensional electro-magnetic receiver array.

3. The system of claim 1, wherein said elements of said two-dimensional electro-magnetic receiver array have a spacing along at least one dimension that is a multiple integer of a similar spacing between elements of said two-dimensional electro-magnetic transmitter array.

4. A detector system, comprising:
a two-dimensional electro-magnetic transmitter array that includes an x number of transmitter elements that transmit at least one output signal;
a two-dimensional electro-magnetic receiver array that includes a y number of receiver elements that provide at least one input signal, said two-dimensional electro-magnetic transmitter and receiver arrays having a spatial relationship such that at least one subset of said two-dimensional electro-magnetic transmitter and receiver arrays forms a regular array of spatial displacements of z pairwise combinations of transmitter and receiver elements, where z is greater than the sum of x and y; and,
a processor that provides said output signal for transmission and receives said input signal, and processes said input and output signals.

5. The system of claim 4, wherein said elements of said two-dimensional electro-magnetic transmitter array have a spacing along at least one dimension that is a multiple integer of a similar spacing between elements of said two-dimensional electro-magnetic receiver array.

6. The system of claim 4, wherein said elements of said two-dimensional electro-magnetic receiver array have a spacing along at least one dimension that is a multiple integer of a similar spacing between elements of said two-dimensional electro-magnetic transmitter array.

7. The system of claim 4, wherein said processor processes said input and output signals to produce a multi-dimensional image of an object.

8. The system of claim 4, further comprising an actuator that moves said two-dimensional electro-magnetic transmitter array.

9. The system of claim 4, further comprising an actuator that moves said two-dimensional electro-magnetic receiver array.

10. The system of claim 4, further comprising an actuator that moves said two-dimensional electro-magnetic transmitter array and said two-dimensional electro-magnetic receiver array.

11. The system of claim 4, wherein n number of said elements in said two-dimensional electro-magnetic transmitter array are sequentially selected and m number of said elements in said two-dimensional electro-magnetic receiver array are sequentially selected, wherein m can equal n.

12. A detector system, comprising:
a two-dimensional electro-magnetic transmitter array that includes an x number of transmitter elements that transmit at least one output signal;
a two-dimensional electro-magnetic receiver array that includes a y number of receiver elements that provide at least one input signal, said two-dimensional electro-magnetic transmitter and receiver arrays having a spatial relationship such that at least one subset of said two-dimensional electro-magnetic transmitter and receiver arrays forms a regular array of spatial displacements of z pairwise combinations of transmitter and receiver elements, where z is greater than the sum of x and y; and,
a processing means for processing said input and output signals.

13. The system of claim 12, wherein said elements of said two-dimensional electro-magnetic transmitter array have a spacing along at least one dimension that is a multiple integer of a similar spacing between elements of said two-dimensional electro-magnetic receiver array.

14. The system of claim 12, wherein said elements of said two-dimensional electro-magnetic receiver array have a spacing along at least one dimension that is a multiple integer of a similar spacing between elements of said two-dimensional electro-magnetic transmitter array.

15. The system of claim 12, wherein said processor means processes said input and output signals to produce a multi-dimensional image of an object.

16. The system of claim 12, further comprising means for moving said two-dimensional electro-magnetic transmitter array.

17. The system of claim 12, further comprising means for moving said two-dimensional electro-magnetic receiver array.

18. The system of claim 12, further comprising means for moving said two-dimensional electro-magnetic transmitter array and said two-dimensional electro-magnetic receiver array.

19. The system of claim 12, wherein n number of said elements in said two-dimensional electro-magnetic transmitter array are sequentially selected and m number of said elements in said two-dimensional electro-magnetic receiver array are sequentially selected, wherein m can equal n.

20. A method for detecting an object, comprising:
providing an antennae assembly that includes;
a two-dimensional electro-magnetic transmitter array that includes an x number of transmitter elements;
a two-dimensional electro-magnetic receiver array that includes a y number of receiver elements, the two-dimensional electro-magnetic transmitter and receiver arrays having a spatial relationship such that at least one subset of the two-dimensional electro-magnetic transmitter and receiver arrays forms a regular array of spatial displacements of z pairwise combinations of transmitter and receiver elements, where z is greater than the sum of x and y;
transmitting at least one output signal as an electro-magnetic wave from the two-dimensional electro-magnetic transmitter array that is reflected from the object;
receiving the reflected electro-magnetic wave at the two-dimensional electro-magnetic receiver array;
converting at least one received reflected electro-magnetic wave into an input signal; and,
processing the input and output signals.

21. The method of claim 20, further comprising processing the input and output signals to produce an image of the object.

22. The method of claim 20, further comprising moving the two-dimensional electro-magnetic transmitter array.

23. The method of claim 20, further comprising moving the two-dimensional electro-magnetic receiver array.

24. The method of claim 20, further comprising moving the two-dimensional electro-magnetic transmitter array and the two-dimensional electro-magnetic receiver array.

25. The method of claim 20, wherein n number of the elements in the two-dimensional electro-magnetic transmitter array are sequentially selected and m number of the elements in the two-dimensional electro-magnetic receiver array are sequentially selected, wherein m can equal n.
